(19) United States
(12) Patent Application Publication
(10) Pub. No.: US 2018/0134946 A1
(43) Pub. Date: May 17, 2018

(54) Compositions and Methods of Using Hydrophobic Coating of Particulates and Cross-Linked Fracturing Fluids for Enhanced Well Productivity

(71) Applicant: Preferred Technology, LLC, Radnor, PA (US)

(72) Inventor: Robert Ray McDaniel, Cypress, TX (US)

(21) Appl. No.: 15/808,089

(22) Filed: Nov. 9, 2017

Related U.S. Application Data
(60) Provisional application No. 62/421,488, filed on Nov. 14, 2016.

(51) Int. Cl. C09K 8/68; C09K 8/80; E21B 43/267; E21B 47/06

(52) U.S. Cl. CPC C09K 8/685; E21B 47/06; E21B 43/267; C09K 8/805

(57) ABSTRACT

Compositions and methods for extracting oil and gas from a fractured subterranean formation are provided.

### CROSS-REFERENCE TO RELATED APPLICATIONS

This application claims priority to U.S. Provisional Application No. 62/421,488, filed Nov. 14, 2016, which is hereby incorporated by reference in its entirety.

### FIELD

Embodiments disclosed herein relate to, for example, treatments for coated or uncoated proppants that can, among other things, enhance well productivity.

### BACKGROUND

Hydraulic fracturing is a technique that is commonly used to enhance oil and gas production. In this process, a large amount of fluid is pumped into a drilled wellbore with targeted areas of the rock are exposed to the fluid. The high pressure fluid induces a crack or fracture in the rock. The hydraulic pressure and type of fracturing fluid system affects the size, depth and surface area of the fracture that allows for hydrocarbon production from the formation. Once the hydraulic pressure is removed the fracturing treatment is completed, the fracture closes in a short over a period of time. In order to keep the fracture open to allow hydrocarbons to escape and be collected, particles called proppants are introduced into the well to “prop” open the fracture. Commonly used proppants are sand or ceramics. The amount of oil or gas produced from the fracture is highly dependent on the quantity and placement of the proppant in the fracture. In most currently treated wells better proppant placement deeper into a well and covering more of the created fracture area will yield a more effective fracture treatment, and thus better production. Therefore, in order to improve hydrocarbon yield from hydraulically fractured wells, any improvement in placement can have a large impact on production.

### SUMMARY

Embodiments disclosed herein provide methods of extracting oil and/or gas from a subterranean stratum. In some embodiments, the methods comprise injecting into the subterranean stratum a mixture of a hydrophobic coated particulate, gas, and a fracturing fluid through a wellhead and into the fractured subterranean stratum, wherein the fracturing fluid comprises a cross-linked or cross-linkable polymer; and extracting the oil and/or gas from the subterranean stratum, wherein the combination of the fluid, gas, and hydrophobic coated particulate results in the hydrophobic coated particulate being suspended for a period of time that approaches or exceeds the time required for the fracture to close thereby maximizing the amount of created fracture area that is held open by hydrophobic coated particulate. In some embodiments, the fluid and the particulate are mixed with a gas prior to or before entering the wellhead.

Embodiments disclosed herein provide methods of determining an optimized proppant and fracturing fluid system for transporting proppants into a fractured subterranean. In some embodiments, the methods comprise determining the time required for the fracture to close; and performing a suspension test on a combination of a proppant, fracturing fluid and gas to determine the combination that is near to or exceeding the time for the fracture to closed at elevated temperatures that are representative of the formation that is to be fracture stimulated, wherein the fracturing fluid, gas and proppant combination that shows it is capable of keeping the coated proppant suspended for the time period identified in a) is selected as the optimized combination.

### DETAILED DESCRIPTION

Embodiments provided herein provided methods and compositions for enhancing hydrocarbon, such as oil and gas, production from a fractured well, that is, a fractured subterranean formation. The present embodiments describe, for example, cross-linked or cross-linkable fracturing fluids in combination with hydrophobic coated proppants (particulates), such as sand, ceramic, and others described herein and a gas such as nitrogen or carbon dioxide. The present embodiments overcome the limitations and drawbacks of previous cross-linked fracturing fluids treatments that exhibited ultra-high viscosities that can limit the fracture area that can be created, create a substantial level of damage to proppant packs and fracture faces while still being unable to keep the proppant suspended (at downhole conditions) long enough for the fracture to close (to trap the proppant between the fracture faces/walls) and result in the maximum amount of created fracture area being held open by a highly conductive proppant pack. In some embodiments, the hydrophobic coating is any coating suitable with the fracturing fluids that are described herein or that can be used in the methods described herein.

The present embodiments also describe fracturing fluids that are prepared by using moderate to low levels of base polymer but when crosslinked still can be characterized as viscoelastic fluids) meaning their viscosity changes with the amount of shear that the fluid encounters). Viscoelastic fluids characteristically exhibit low viscosity at high shear rates for example about 10 to about 100 centipoise (at the shear conditions experienced while being pumped through tubular goods) and higher viscosity for example about 200 to about 1000 centipoise at the relatively low shear rates experienced when moving through the fracture. Being able to limit the base polymer concentrations (that are utilized in the crosslinked fluid formulations) not only lowers treatment costs but also insures that there is a limited amount of fracture pack conductivity damage that can be attributed to the fracturing fluid system. Additionally, the embodiments provided herein overcome other issues with previously used crosslinked fracturing fluid systems because previous systems could only improve proppant suspension and transport by increasing the base polymer loading and making the fracturing fluid more viscous. This type approach also resulted in the creation of larger dynamic fracture widths that translated to less created fracture area and more fluid having to leak off in order for the fracture walls to close to the point that there is a contact with the proppant particles. The previous systems were not ideal because larger dynamic widths correlates to more fluid to leak-off which translates to a longer time that the proppant must be kept in suspension or the proppant will settle leaving a significant part of the created fracture area unpropped. Although the previous systems possessed high viscosity, they still exhibited a limited ability to keep proppant suspended (at downhole conditions of elevated temperature). The present embodiments overcomes these issues because the combination of the fracturing fluids with desired properties, as described herein, a hydrophobic coated particulates (proppants) and gas creates a condition that approaches “perfect proppant transport and suspension”. This condition essentially describes an ability to keep the proppant uniformly distributed in the fracturing fluid with minimum proppant settling for an extended period of time (at the elevated temperature that is characteristic of downhole conditions found in the formation). Keeping the proppant suspended for a period of time approaching what is required for the fracture to close will result in a maximum amount of the created fracture area being propped open. With this result, the well is able to produce at a higher initial rate and for a longer period of time.

The present embodiments also overcome the issues of simply using lighter proppants. Although so called lighter proppants may sound like a reasonable approach, but these have had a low crush resistance or a high rate of deformation resulting in a multilayer proppant pack having an unacceptable conductivity. These issues have suggested to others to utilize monolayers of the light weight proppant (as an alternative to multilayer packs). However, none of the attempts to alter proppant density or proppant placement could be confirmed as resulting in the targeted production increases. The present embodiments also overcome these issues because although the coated proppant exhibit a lower apparent density, the proppants have sufficient crush resistance and the proppant pack that is created has acceptable conductivity.

Crosslinked or crosslinkable fracturing fluids are also more expensive and the disadvantages noted above do not justify their cost without a solution to overcome the problems noted herein and known to one of skill in the art. The embodiments described herein overcome these problems and shift the economics of using crosslinked or crosslinkable fracturing fluids. By combining certain fluids with the hydrophobic coated particulates described herein more of the created fracture geometry can be propped open to ensure that the well can be kept open longer and production is enhanced at higher initial rates and remain profitable for a longer period of time because it is kept open longer and, thus, production is enhanced. Therefore, the cost is justified because of increased well productivity.

Accordingly, in some embodiments, a hydrophobic coated particulate (proppant) can be combined with a crosslinked fracturing fluid. The hydrophobic coating can be any coating, such as, but not limited to those described herein. Hydrophobic coatings are also described in U.S. patent application Ser. No. 15/073,840, filed Mar. 18, 2016, and PCT Application No. PCT/US2016/032104, filed May 12, 2016, each of which is incorporated by reference in its entirety. These applications also describe how to make such coatings.

In some embodiments, the crosslinked fluid systems is system that comprises about 15 to about 40 pounds of crosslinked or crosslinkable polymer per 1000 gal of fluid. In some embodiments, the base viscosity (before crosslinking) is about 10 to 60 centipoises. The viscosity can be measured, for example, by a Brookfield DV-E viscometer being operated at 60 RPM's. This level of viscosity in the base gels (before crosslinking) has been found to not significantly hinder the distribution of nitrogen in the proppant laden slurry or the subsequent development of the gas bubbles covering the sand's surface.

As described herein, the crosslinked fluid and the hydrophobic coated particulate can also be mixed with a gas, such as nitrogen or other gases described herein. The gas will create bubbles that adhere to the coated particulates and assist in the suspension of the particulates in the fluid. Without being bound to any particular theory, once the gas (e.g., nitrogen) is dispersed and adhered to the hydrophobic coated particulates, the crosslinker converts the fluid to a viscous crosslinked structure that now surrounds the bubble covered hydrophobic coated. Additionally, an added benefit is that any unattached gas (nitrogen) will be left in the crosslinked gel structure to further hinder proppant settling. Accordingly, in some embodiments, there is a proppant support benefit from the nitrogen bubbles even if they do not get attached to a proppant grain.

This combination of the suspension properties of the crosslinked fracturing fluid structure and the lower apparent density of the bubble coated proppant grains results in superior suspension of the hydrophobic coated particulate wherever it is located in the created fracture geometry. In some embodiments, the hydrophobic coated particulate can remain in suspension until such time as the crosslinked fluid structure degrades (due to either the downhole environment, the effect of a fracturing fluid breaker or both) to the point it has limited ability to suspend. If the degradation of the fracturing fluid (which results in the inability to suspend the proppant) happens before the fracture is sufficiently healed/closed then proppant settling will occur and the amount of created fracture (that will be propped open) will start decreasing. If the degradation of the crosslinked fracture structure is controlled to the point that the fracture heals/closes to trap the proppant before the fluid reaches an inability to suspend the particles, then the maximum amount of created fracture area will be held open by the proppant that was pumped. Although various polymer loadings are described herein, it can be desirable to choose the lowest base polymer loading that will minimize treatment costs; generate the required dynamic fracture width (to allow the fracture to accept the full amount of proppant being pumped) but not an excessive width that will limit the growth of the fracture in the horizontal or vertical directions; be capable of adequately transporting the desired proppant concentrations during the fracturing treatment; be able to maintain the fluid's crosslinked structure (ability to suspend proppant) at down hole conditions until the fracture is near or at closure; be able to break down to the point that it creates minimal conductivity damage to the formation or proppant pack; or a combination thereof. Accordingly, in some embodiments, the polymer loading is about 10, about 20, about 30, about 40, about 50, about 60 pounds of polymer per 1000 gallons of fracturing fluid. In some embodiments, the polymer loading is about 10 to about 20, about 10 to about 30, about 10 to about 40, about 10 to about 50, about 10 to about 60, about 20 to about 30, about 20 to about 40, about 20 to about 50, about 20 to about 60, about 30 to about 40, about 30 to about 50, about 30 to about 60 pounds, of polymer per 1000 gallons of fracturing fluid. In some embodiments, the fracturing fluid exhibit low viscosity at high shear rates for example less than 100 centipoise (at the shear conditions experienced while being pumped through tubular goods), or about 20 to about 40 centipoise and higher viscosity, for example, about 2 to about 400 centipoise at the relatively low shear rates experienced when moving through the fracture.

The embodiments described herein can, in some embodiments, result in twice even three times the propped fracture area that is normally generated in a conventional crosslinked fracturing treatment or “slick water” treatment design.

In some embodiments, the fluids are combined with hydrophobic polymer coated particulates (proppants). The coated particulates can provide a hydrophobic surface that can enhance proppant transport into a fracture during the process of hydraulic fracturing. This can enhance the productivity of the well. This enhanced transport can be when the particulates are in combination with a gas phase in the fracturing fluid/slurry. Additional coatings and coated particulates are also described herein. The coatings can be applied through the use of one or more treatment agents. The treatment agents can be a single agent or a combination of agents. Non-limiting examples of such singular agents or combinations are provided herein.

“Treatment agents” that can be used to produce hydrophobic coated particulates are described herein. They can be liquid treatment agents. Examples, include, but are not limited to an aqueous solution, dispersion, or emulsion. The treatment agent can also be a combination of solids that are applied to the particulate core that makes up the proppant. The treatment agents can be heated or not heated before, after, or during the application processes described herein. In some embodiments, the treatment agent is not heated before, after, or during the application process. In some embodiments, the treatment agent is heated on the particulate downhole or in the well.

Free-flowing proppant solids can be treated with a treatment agent, such as those disclosed herein, quickly and at a sufficiently low application rate in order to maintain the free-flowing properties of the treated solids. Without wishing to be bound by any particular theory, such low levels of treatment with the agents allow the treated solids to be handled with conventional handling equipment without adversely affecting the handling and conveying process. The treatment agent can also help to avoid the degradation or deterioration of the proppant solids. Some of the unexpected advantages of the processes and compositions described herein include, but are not limited to, preserving sphericity and the crush resistance benefits associated with the proppants while avoiding the formation of fines (e.g. dust) that can become an airborne health hazard or in a high enough concentration to affect the properties of the fracturing fluid or damage the conductivity of the proppant. Embodiments described herein can also be used to provide the proppant with additional functions and/or benefits of value for oil and gas well operation by incorporating functional molecules into the coating. The coatings can also be added using traditional techniques such as using heat and other resin coating methods. The coatings can also provide a hydrophobic coating as described herein. The coatings can also be supplemented with other elements and coatings as described herein. Any coating described herein can be combined with one another. The coatings can also be applied according as described in U.S. patent application Ser. No. 15/073,840, filed Mar. 18, 2016, and PCT Application No. PCT/US2016/032104, filed May 12, 2016, each of which is incorporated by reference in its entirety. These are non-limiting examples and other coatings can be used. In some embodiments, the coating is a polyurethane coating. In some embodiments, the polyurethane coating is a layer on top of a silane that has been coated onto the particulate. In some embodiments, the silane is as described herein. In some embodiments, the coated particulate comprises an inner silane layer that is then coated by an outer polyurethane layer.

In some embodiments, the coated particulate comprises a particulate core coated with a compatibilizing agent and a hydrophobic polymer coating the particulate core. In some embodiments, a portion of the hydrophobic polymer is exposed to provide an exposed hydrophobic surface of the coated particulate. The compatibilizing agent can be any agent that facilitates the binding of the hydrophobic polymer to the particulate core. For example, when hydrophobic polymers are mixed with particulate cores without a compatibilizing agent the hydrophobic polymer can flake off and leave the particulate core without a coating or a sufficient coating. Thus, the compatibilizing agent can enhance the hydrophobic coating by enabling the hydrophobic polymer to more readily bind to the particulate core. In some embodiments, a compatibilizing agent can refer to a coupling reagent. Non-limiting examples of compatibilizing agents are provided herein, however, any agent that can facilitate the binding of the hydrophobic polymer to the particulate core can be used. Examples of hydrophobic polymers are also provided herein, but others can be also be used. Without wishing to be bound by any particular theory, the hydrophobic coating provides the following functionality. Hydrophobic polymers containing groups that have low surface energy that imparts an enhanced chemical affinity for non-polar nitrogen molecules, and thus supports the formation of bubbles or a plastron (trapped film or air) to form on the surface of the polymer. The bubbles or plastron will generate increased buoyancy of the particles and thus enhance the transport in a flowing fluid media. Polymers with functional groups or side chains that contain aliphatic methyl, ethyl, propyl, butyl and higher alkyl homologs can be used to generate this type of effect. Polymers with fluoro groups also impart low surface energies and oleophobic as well as hydrophobic character. Examples of these include trifluoromethyl, methyldifluoro (vinilidyine fluoride copolymers, hexafluoropropyl containing polymers, side chains that contain short chains of fluoropolymers and the like. Therefore, these polymers can also be used in some embodiments. Commercially available fluorosilicones can also be used. Examples of hydrophobic polymers include, but are not limited to, polybutadienes. Examples of such polybutadienes include, but are not limited to, non-functionalized polybutadienes, maleic anhydride functionalized polybutadienes, hydroxyl, amine, amide, keto, aldehyde, mercaptan, carboxylic, epoxy, alkoxy silane, azide, halide terminated polybutadienes, and the like, or any combination thereof. One non-limiting example includes those sold under the tradename Polyvest and the like. In some embodiments, the hydrophobic polymer may be a di-, tri-, or ter-block polymers or a combination thereof that are terminated with hydroxyl, amine, amide, mercaptan, carboxylic, epoxy, halide, azide, or alkoxy silane functionality. Examples of such diblock and triblock or terblock polymers backbone are not limited to styrene butadiene, acrylonitrile butadiene styrene, acrylonitrile butadiene, ethylene-acrylate rubber, polyacrylate rubber, isobutylene isoprene butyl, styrene ethylene butylene styrene copolymer, styrene butadiene carboxy block copolymer, chloro isobutylene isoprene, ethylene-acrylate rubber, styrene-acrylonitrile, poly(ethylene-vinyl acetate) polyethyleneglycol-polylactic acid, polyethyleneglycol-polylactide-co-glycolide, polystyrene-co-poly(methyl methacrylate), poly(styrene-block-maleic anhydride), poly(styrene)-block-poly(acrylic acid), Poly(styrene-co-methacrylic acid, poly(styrene-co-α-methylstyrene), poly(ε-caprolactone)-poly(ethylene glycol), styrene-isoprene-styrene, and the lie. The polymer that forms the hydrophobic coating can also be a cured polymer as described herein.

In some embodiments, the compatibilizing agent binds the hydrophobic polymer to the particulate. In some embodiments, the compatibilizing agent encapsulates the particulate core and a first surface of the hydrophobic polymer binds to the compatibilizing agent and a second surface of the hydrophobic polymer is exposed to provide the exposed hydrophobic surface of the coated particulate.

In some embodiments, the coated particulate has enhanced particulate transport as compared to a particulate without the exposed hydrophobic surface. The enhanced transport can be in the presence of a gas, such as but not limited to nitrogen gas, carbon dioxide, air, nonpolar gases, or any combination thereof.

Examples of compatibilizing agents include, but are not limited to, silanes, surfactants, alkoxylated alcohol, acrylate polymer, or combinations thereof. The compatibilizing agent ca also be a combination of two or more of such agents. In some embodiments, the compatibilizing agent is a mixture of 2, 3, 4, or 5 of such agents. The surfactant is not being used as a frother, or ingredient which is designed to be released into the fluid media to enhance bubble formation, but rather as a compatibilizing agent or a coupling agent that enables the hydrophobic polymer to better bind to the particulate core. In some embodiments, the silane is an alkoxysilane. Examples of alkoxysilanes include, but are not limited to, methoxmethylsilane, ethoxysilane, butoxysilane, or octoxysilane including, but not limited to, Dynasylan® or Geniosil®.

An example of a surfactant that can be used as a compatibilizing agents includes, but is not limited to a hydroxysultaine. A non-limiting example of a hydroxysultaine is cocamidopropyl hydroxysultaine.

Non-limiting examples of alkoxylated alcohols are, but not limited to, Brij™ or Ecosurf™ products.

Various hydrophobic polymers are described herein that can be used in conjunction with the compatibilizing agent. In some embodiments, the coated particulate with a coating comprising a compatibilizing agents and a hydrophobic polymer comprises a hydrophobic polymer that is a polyalphaolefin, such as but not limited to, an amorphous polyalphaolefin. In some embodiments, the polyalphaolefin is crosslinked. The crosslinking of the polyolefins can, for example, improve the durability of the coating. An improvement in durability can refer to the ability of a material to retain its physical properties while subjected to stress such as heavy use or environmental conditions as opposed to the particulate core without the coating. For example, the improved durability can include, but not limited to, maintenance of chemical properties as well as physical properties, such as maintenance of hydrophobicity, barrier properties, chemical functionality, and the like. The polyalphaolefin can be crosslinked by any method suitable to crosslink a polyalphaolefin. For example, crosslinking of polyolefins may be performed in a similar manner as crosslinking of polyethylene, which is commonly practiced in the pipe industry, and often called PEX (for crosslinked polyethylene). The cross-linking of the hydrobphobic coating, such as a crosslinked polyalphaolefin can improve the performance of the coated particulate core. For example, the improvements can include, but are not limited to, enhanced environmental stress crack resistance, resistance to crack growth, increase in yield strength, increased creep resistance, increased chemical resistance, and the like. Additionally, the cross-linked polymers should not melt, which enhances the durability of the coating at higher temperatures, such as those experienced downhole in a well by a particulate core coating. The cross-linking can be performed by using radical initiators such as peroxides, as given in table 5 of Tamboli et al., Indian Journal of Chemical Technology, Vol. 11, pp. 853-864, which is hereby incorporated by reference in its entirety. Examples of the radical initiators, include but are not limited to, dicumyl peroxide, di-t-butyl peroxide, di-t-amyl peroxide, 2,5-dimethyl-2,5-di (t-butyl-peroxy) hexane, 2,5-dimethyl-2,5-di (t-butyl-peroxy) hexynes, n-butyl-4,4-bis (t-butyl peroxy) valerate, 1,1-Bis (t-butyl peroxy)-3,3,5-tri methylcyclohexane, benzoyl peroxide, and the like, or any combination thereof. The polyalphaolefin polymer may also be crosslinked by irradiation, such as electron beam, or by grafting of reactive silanes to the polymer. Crosslinking by chemical radical initiators provides an advantage because the process requires standard chemical process equipment, as opposed to irradiation processes. In some embodiments, dicumyl peroxide and AIBN (azoisobutyronitrile) are used as a radical initiator, to crosslink the polyalphaolefin polymer. One non-limiting example of a polyalphaolefin polymer for crosslinking is VESTOPLAST® W-1750 (amorphous poly-alpha-olefins dispersion), an amorphous polyalphaolefin polymer in an aqueous dispersion.

In some embodiments, the hydrophobic polymer is a polybutadiene. Examples of such polybutadienes include, but are not limited to, non-functionalized polybutadienes, maleic anhydride functionalized polybutadienes, hydroxyl, amine, amide, keto, aldehyde, mercaptan, carboxylic, epoxy, alkoxy silane, halide, azide terminated polybutadienes, and the like, or any combination thereof. One non-limiting example includes those sold under the tradename Polyvest and the like. In some embodiments, the hydrophobic polymer is a non-siloxane hydrophobic polymer.

In some embodiments, the hydrophobic polymer is a copolymer or a graft polymer. In some embodiments, the copolymer and/or the graft polymer comprises both hydrophilic groups and hydrophobic groups, provided that the majority of groups are hydrophobic groups. In some embodiments, the hydrophilic groups bond with the particulate surface through van der Waals forces. In some embodiments, the hydrophilic groups are an ether, amine, amide, ethoxylated alcohol, ester, urethane, alkoxy silane, carboxylic, epoxy, mercaptan, halide, keto, aldehyde, azide or any combination thereof.

In some embodiments, the hydrophobic polymer is a low molecular weight polymer below or slightly above the critical entanglement chain length (which varies by polymer). For example, critical molecular weights (Mc or Me) can range from 3,000 to 350,000 depending on the polymer (See Mark “Physical Properties of Polymers Handbook, Chapter 25 Tables 25.2-25.6. In some embodiments, the low molecular weight polymer is a hydrophobic olefin polymer. In some embodiments, the hydrophobic polymer has a crosslinkable moiety. In some embodiments, the hydrophobic polymer has an irregular backbone or pendant groups that disrupt crystallization.

In some embodiments, the hydrophobic coated particle is coated with a combination of an ethoxylated alcohol, an acrylic polymer(s), and an alphaolefin (e.g. amorphous polyalphaolefins). In some embodiments, the particle is coated by contacting the particle with an emulsion, which can also be referred to as an aqueous composition, comprising the ethoxylated alcohol and an acrylic polymer and a composition comprising the alphaolefin. In some embodiments, the alphaolefin is a polyalphaolefin, such as but not limited to, an amorphous polyalphaolefin. Examples are described herein and include, but are not limited to, Evonik VESTOPLAST® W-1750 (amorphous poly-alpha-olefins dispersion). Examples of emulsions that can be used are described in, for example, WO2015/073292, which is hereby incorporated by reference in its entirety. Ethoxylated alcohols can also be referred to as a surfactant.

The surfactant may be a nonionic, cationic, or anionic material, and it may be a blend of surfactants. Non-limiting examples of surfactants known in the art that may suitably be used include those described in U.S. Pre-Grant publication 2002/0045559, which is incorporated herein by reference. Examples of appropriate anionic surfactants may include, but are not limited to, a sulfonic acid surfactant, such as a linear alkyl benzene sulfonic acid, or salt thereof. Anionic sulfonate or sulfonic acid surfactants suitable for use herein include the acid and salt forms of C₅-C₂₀, C₁₀-C₁₆, C₁₁-C₁₃ alkylbenzene sulfonates, alkyl ester sulfonates, C₆-C₂₂ primary or secondary alkane sulfonates, sulfonated polycarboxylic acids, and any mixtures thereof. In some embodiments, it is a C₁₁-C₁₃ alkylbenzene sulfonates. Anionic sulfate salts or acids surfactants include the primary and secondary alkyl sulfates, having a linear or branched alkyl or alkenyl moiety having from 9 to 22 carbon atoms or C₁₂ to C₁₈ alkyl can also be used.

Anionic surfactants that may be used also include beta-branched alkyl sulfate surfactants or mixtures of commercially available materials, having a weight average (of the surfactant or the mixture) branching degree of at least 50% or even at least 60% or even at least 80% or even at least 95%. Mid-chain branched alkyl sulfates or sulfonates are also suitable anionic surfactants for use. In some embodiments, the mid-chain branched alkyl sulfates are used.

Suitable mono-methyl branched primary alkyl sulfates that may be used include those selected from the group consisting of: 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, and mixtures thereof.

Suitable di-methyl branched primary alkyl sulfates may include materials selected from the group consisting of: 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,1-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof.

Examples of cationic surfactants that may be used include, but are not limited to, cationic mono-alkoxylated and bis-alkoxylated quaternary amine surfactants with a C₆-C₁₈ N-alkyl chain, such as of the general formula:

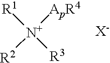

wherein R¹ is an alkyl or alkenyl moiety containing from about 6 to about 18 carbon atoms, preferably 6 to about 16 carbon atoms, most preferably from about 6 to about 14 carbon atoms; R² and R³ are each independently alkyl groups containing from one to about three carbon atoms, e.g., methyl or where both R² and R³ are methyl groups; R⁴ is selected from hydrogen, methyl and ethyl; X is an anion such as chloride, bromide, methylsulfate, sulfate, or the like, to provide electrical neutrality; A is an alkoxy group, such as an ethyleneoxy, propyleneoxy or butyleneoxy group; and p is from 0 to about 30, 2 to about 15, 2 to about 8.

In some embodiments, The cationic bis-alkoxylated amine surfactant has the general formula:

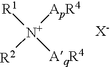

wherein R¹ is an alkyl or alkenyl moiety containing from about 8 to about 18 carbon atoms, about 10 to about 16 carbon atoms, or about 10 to about 14 carbon atoms; R² is an alkyl group containing from one to three carbon atoms, such as methyl; each R4 can vary independently and are selected from hydrogen, methyl and ethyl, X⁻ is an anion such as chloride, bromide, methylsulfate, sulfate, or the like, sufficient to provide electrical neutrality. A and A′ can vary independently and are each selected from C₁-C₄ alkoxy, such as, ethyleneoxy, propyleneoxy, butyleneoxy and mixtures thereof; p is from 1 to about 30, 1 to about 4 and q is from 1 to about 30, 1 to about 4. In some embodiments, both p and q are 1.

Another suitable group of cationic surfactants which can be used are cationic ester surfactants. Suitable cationic ester surfactants, including choline ester surfactants, have for example been disclosed in U.S. Pat. Nos. 4,228,042, 4,239,660 and 4,260,529, each of which are hereby incorporated by reference in its entirety.

In some embodiments, nonionic surfactants are used (including blends thereof). Suitable nonionic surfactants include, but are not limited to, alkoxylate materials including those that are derived from ethylene oxide, propylene oxide, and/or butylene oxide. Examples are described, for example, in U.S. Pat. No. 7,906,474 and U.S. Pre-Grant publication 2011/0098492, each of which is incorporated herein by reference.

In some embodiments, the surfactant is a nonionic alkoxylate of the formula I:

RₐO-(AO)₂—H (I)

wherein Rₐ is aryl (e.g., phenyl), or linear or branched C₆-C₂₄ alkyl, AO at each occurrence is independently ethyleneoxy, propyleneoxy, butyleneoxy, or random or block mixtures thereof, and z is from 1 to 50.

In some embodiments, the nonionic surfactant for use in the aqueous (emulsion) coating composition is an alkoxylate represented by the following formula II:

R—O—(C₃H₆O)ₓ(C₂H₄O)_{y}—H (II)

wherein x is a real number within a range of from 0.5 to 10; y is a real number within a range of from 2 to 20, and R represents a mixture of two or more linear alkyl moieties each containing one or more linear alkyl group with an even number of carbon atoms from 4 to 20. One of the advantages of surfactants, particularly those that are natural source derived, as described below, is their general biodegradability and low toxicity.

Formula II surfactants can be prepared in a sequential manner that includes propoxylation (adding PO or poly(oxypropylene)) moieties to an alcohol or mixture of alcohols to form a PO block followed by ethoxylation (adding EO or poly(oxyethylene)) moieties to form an EO block attached to the PO block, but spaced apart from R which represents alkyl moieties from the alcohol or mixture of alcohols. One may either begin with a mixture of alcohols that provides a distribution of alkyl moieties and then sequentially propoxylate and ethoxylate the mixture or separately propoxylate and ethoxylate select alcohols and then combine such alkoxylates (propoxylated and ethoxylated alcohols) in proportions sufficient to provide a distribution, for example, as shown in the Table below.

In some embodiments, R (as shown in the formula) represents a mixture of linear alkyl moieties that are the alkyl portions of seed oil-derived alcohols. In some embodiments, R has an alkyl moiety distribution as in the table below (Table A):

TABLE A

| Amount | Alkyl Moieties |
|---|---|
| 0 wt % to 40 wt % | C₆ |
| 20 wt % to 40 wt % | C₈ |
| 20 wt % to 45 wt % | C₁₀ |
| 10 wt % to 45 wt % | C₁₂ |
| 0 wt % to 40 wt % | C₁₄ |
| 0 wt % to 15 wt % | C₁₆₋₁₈ |

In reference to the alkyl moieties, C₁₆₋₁₈ means C₁₆, C₁₈, or a mixture thereof. Any one or more of C₆, C₁₄, and C₁₆₋₁₈ alkyl moieties may, but need not be, present. When present, the amounts of C₆, C₁₄, and C₁₆₋₁₈ alkyl moieties may satisfy any of their respective ranges as shown in the table above as long as all weight percentages total 100 wt %. In some embodiments, one or more of C₆, C₁₄, and C₁₆₋₁₈ alkyl moieties are present in an amount greater than zero. In some embodiments, C₆ and C₁₄ are each present in an amount greater than zero, and there is also an amount greater than zero of C₁₆₋₁₈.

In some embodiments, R has an alkyl moiety distribution as in the following table (Table B).

TABLE B

| Amount | Alkyl Moieties |
|---|---|
| 0 wt % to 36 wt % | C₆ |
| 22 wt % to 40 wt % | C₈ |
| 27 wt % to 44 wt % | C₁₀ |
| 14 wt % to 35 wt % | C₁₂ |
| 5 wt % to 13 wt % | C₁₄ |
| 0 wt % to 5 wt % | C₁₆₋₁₈ |

The surfactant mixture in this table includes a mixture of at least four alkyl moieties: C₈, C₁₀, C₁₂, and C₁₄. Any one or more of C₆ and C₁₆₋₁₈ alkyl moieties may, but need not be, present in compositions. When present, the amounts of C₆ and C₁₆₋₁₈ alkyl moieties may satisfy any of their respective ranges as shown in the table as long as all weight percentages total 100 wt %. In some embodiments, the amount of C₆ in R is zero. Independently, in some embodiments, the amount of C₁₆₋₁₈ in R is not zero.

Formula II above includes variables “x” and “y” that, taken together, establish a degree of alkoxylation in an oligomer distribution. Individually, “x” and “y” represent average degrees of, respectively, propoxylation and ethoxylation. In some embodiments, the degree of propoxylation or “x” falls within a range of from 0.5 to 7, within a range of 0.5 to less than 4, within a range of from 0.5 to 3, within a range of from 2 to 3, and within a range of from 2.5 to 3. In some embodiments, the degree of ethoxylation or “y” falls within a range of from 2 to 10, within a range of from 2 to 8, within a range of from 4 to 8, or within a range of from 6 to 8.

The term “within a range” as used herein and throughout includes the endpoints. In some embodiments, the sum of x and y is 1 to 15. In some embodiments, the sum of x and y is 1 to 7. Independently, in some embodiments, y is greater than x. In some embodiments, y is greater than or equal to 2 times x. In some embodiments, x is within a range of from 2.5 to 3, y is within a range of from 2 to 10, and R has an alkyl moiety distribution as in Table B. In some embodiments, the amount of C₆ in R is zero, the amount of C₁₆₋₁₈ in R is not zero, and the sum of x and y is 1 to 7.

In some embodiments, the formula II surfactant is C₈₋₁₆O(PO)_{2.5}(EO)₅H (based on raw material feeds) derived from an alcohol stream that provides an alkyl moiety weight percentage distribution as follows: C₈=22.5%, C₁₀=27.5%, C₁₂=35%, C₁₄=12.5 and C₁₆=2.5%.

In some embodiments, the formula II surfactant is a blend of C₈₋₁₀O(PO)_{2.5}(EO)_{5.8}H (derived from an alcohol blend consisting of about 55% n-decanol and about 45% noctanol) and C₁₂₋₁₆(PO)_{2.5}(EO)8H (derived from an alcohol blend consisting of about 70% n-dodecanol, 25% n-tetradecanol and 5% n-hexadecanol), such as at a ratio of the two formula II materials of 65:35.

In some embodiments, the surfactant for use in the aqueous coating composition of is an alkoxylate of the formula III:

R¹O—(CH₂CH(R²)—O)ₚ—(CH₂CH₂O)_{q}—H (III)

wherein R¹ is linear or branched C₄-C₁₈ alkyl; R² is CH₃ or CH₃CH₂; p is a real number from 0 to 11; and q is a real number from 1 to 20. In some embodiments, R¹ in formula III is linear or branched C₆-C₁₆ alkyl, alternatively linear or branched C₈-C₁₄ alkyl, alternatively linear or branched C₆-C₁₂ alkyl, alternatively linear or branched C₆-C₁₀ alkyl, alternatively linear or branched C₈-C₁₀ alkyl. In some embodiments, R¹ is linear or branched C₈ alkyl. In some embodiments, R¹ is 2-ethylhexyl (CH₃CH₂CH₂CH₂CH(CH₂CH₃)CH₂—). In some embodiments, R¹ is 2-propylheptyl (CH₃CH₂CH₂CH₂CH₂CH(CH₂CH₂CH₃)CH₂—). In some embodiments, R² in formula III is CH₃. In some embodiments, R2 is CH₃CH₂. In some embodiments, p in formula III is from 3 to 10, alternatively from 4 to 6. In some embodiments, q in formula III is from 1 to 11, alternatively from 3 to 11.

In some embodiments, the formula III surfactant is C₈-C₁₄O—(PO)₂₋₅(EO)₅₋₉—H, where the C₈-C₁₄ group is linear or branched. In some embodiments, it is branched. In some embodiments, the formula III surfactant is 2EH(PO)₂(EO)₄—H, 2EH(PO)₃(EO)₆₈—H, 2EH(PO)₅₅(EO)₈—H, 2EH(PO)₉(EO)₉—H, 2EH(PO)₁₁(EO)₁₁—H, 2EH(PO)₅(EO)₃—H, or 2EH(PO)₅(EO)₆—H, wherein 2EH is 2-ethylhexyl.

In some embodiments, the surfactant for use in the aqueous coating composition is an alkoxylate of the formula IV:

Rₐ—O—(C₂H₄O)ₘ(C₄H₈O)ₙ—H (IV)

wherein Rₐ is one or more independently straight chain or branched alkyl groups or alkenyl groups having 3-22 carbon atoms, m is from 1 to 12, and n is from 1 to 8. In some embodiments, m may be from 2 to 12, or from 2 to 10, or from 5-12. In some embodiments, n may be from 2 to 8, from 3-8, or from 5 to 8.

In some embodiments, the surfactant for use in the aqueous coating composition is an alkoxylate of the formula V:

C₄H₉O—(C₂H₄O)ᵣ(C₃H₉O)ₛ(C₂H₄O)ₜ—H (V)

wherein r is from 3-10, s is from 3 to 40, and t is from 10 to 45.

In some embodiments, the surfactant is an alkoxylate of the formula VI:

R—O—(-CH—CH₃—CH₂—O—)ₓ-(—CH₂—CH₂—O—)_{y}-H (VI)

wherein x is from 0.5 to 10, y is from 2 to 20, and R is a mixture of two or more linear alkyl moieties having an even number of carbon atoms between 4 and 20.

In some embodiments, the surfactant for use in the aqueous coating composition is an alkyl polyglucoside of the formula:

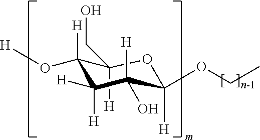

wherein m is from 1 to 10 and n is from 3 to 20.

In some embodiments, the emulsion comprises, based on the total weight, of the aqueous coating composition, from about 2 to 65 weight percent of a surfactant (e.g. ethoxylated alcohol), from about 1 to about 35 weight percent of a polymer binder, and balance water. In some embodiments, the polymer binder comprises an aqueous dispersion of particles made from a copolymer, based on the weight of the copolymer, comprising: i) from 90 to 99.9 weight percent of at least one ethylenically unsaturated monomer not including component ii; and ii) from 0.1 to 10 weight percent of (meth)acrylamide. In some embodiments, the polymer binder comprises an aqueous dispersion of particles made from a copolymer, based on the weight of the copolymer, comprising i) from 80 to 99.9 weight percent of at least one ethylenically unsaturated monomer not including component ii; and ii) from 0.1 to 20 weight percent of a carboxylic acid monomer. In some embodiments, the polymer binder comprises an aqueous dispersion of particles made from a copolymer, based on the weight of the copolymer, comprising: i) from 75 to 99 weight percent of at least one ethylenically unsaturated monomer not including component ii; ii) from 1 to 25 weight percent of an ethylenically unsaturated carboxylic acid monomer stabilized with a polyvalent metal.

In some embodiments, herein the ethylenically unsaturated carboxylic acid monomer is (meth)acrylic acid. In some embodiments, the polyvalent metal is zinc or calcium. In some embodiments, the polymer binder comprises a vinyl aromatic-diene copolymer. In some embodiments, as described herein, the surfactant is an alkoxylated.

In some embodiments, the emulsion is an aqueous coating composition, the aqueous coating composition comprising, based on the total weight of the aqueous coating composition, from 2 to 65 weight percent of a nonionic alkoxylate surfactant; from 1 to 35 weight percent of a polymer binder derived from butyl acrylate, styrene, acrylamide, and optionally hydroxyethyl methacrylate; and balance water.

The coatings can also have an optical brightener. In some embodiments, the optical brightener is coumarin or a coumarin derivative, a bis-stilbene compound, a bis(benzoxazolyl) thiophene compound, a 4,4′-bis(2-benzoxazolyl)stilbene compound, or a mixture of two or more thereof.

In some embodiments, the aqueous coating composition may optionally comprise a flocculant. Suitable flocculants include, without limitation, a water soluble poly(ethylene oxide) resin or an acrylamide resin (e.g., Hydrolyzed Poly-Acrylamide, “HPAM”) or other flocculating agent. In some embodiments, the flocculant, if used, is present in the aqueous coating composition at a concentration of from 0.01 to 5 weight percent, from 0.02 to 2, based on the total weight of the aqueous composition.

Examples of polymer binders suitable for use in the aqueous coating compositions are water insoluble emulsion polymers derived from one or more ethylenically unsaturated monomers, typically in the form of an aqueous dispersion. Suitable ethylenically unsaturated monomers include ethylenically unsaturated carboxylic acids, such as (meth)acrylic acid, derivatives thereof, such as (C₁-C₂₀)alkyl (meth)acrylate esters and (meth)acrylamide, vinyl aromatic monomers, vinyl alkyl monomers, alpha olefins, and combinations thereof. Further examples of suitable monomers include, without limitation, methyl acrylate, ethyl acrylate, propyl acrylate, isopropyl acrylate, butyl acrylate, isobutyl acrylate, secondary butyl acrylate, tertiary-butyl acrylate, methyl methacrylate, ethyl methacrylate, propyl methacrylate, isopropyl methacrylate, cyclopropyl, methacrylate, butyl methacrylate and isobutyl methacrylate, hexyl and cyclohexyl methacrylate, cyclohexyl acrylate, isobornyl methacrylate, 2-ethylhexyl acrylate (EHA), 2-ethylhexyl methacrylate, octyl (meth)acrylate, decyl (meth)acrylate, isodecyl (meth)acrylate, undecyl (meth)acrylate, dodecyl (meth)acrylate (also known as lauryl (meth)acrylate), tridecyl (meth)acrylate, tetradecyl (meth)acrylate (also known as myristyl (meth)acrylate), pentadecyl (meth)acrylate, hexadecyl (meth)acrylate (also known as cetyl (meth)acrylate), heptadecyl (meth)acrylate, octadecyl (meth)acrylate (also known as stearyl (meth)acrylate), nonadecyl (meth)acrylate, eicosyl (meth)acrylate, hydroxyethyl methacrylate, styrene, alpha-methyl styrene and substituted styrenes, such as vinyl toluene, 2-bromostyrene, 4-chlorostyrene, 2-methoxystyrene, 4-methoxystyrene, alpha-cyanostyrene, allyl phenyl ether and allyl tolyl ether, ethylene, propylene, butene, hexene, octane, decene, vinyl acetate (optionally copolymerized with an acrylate, such as butyl acrylate, or with ethylene), and combinations thereof. In some embodiments monomers include methyl acrylate, ethyl acrylate, butyl acrylate and 2-ethylhexyl acrylate, optionally in combination with a vinyl aromatic monomer. In some embodiments it is styrene. In some embodiments it is butyl acrylate optionally in combination with a vinyl aromatic monomer, such as styrene.

Further examples include, without limitation, ethylenically unsaturated (C₃-C₉) carboxylic acid monomers, such as unsaturated monocarboxylic and dicarboxylic acid monomers. For example, unsaturated monocarboxylic acids include acrylic acid (AA), methacrylic acid (MAA), alpha-ethacrylic acid, beta-dimethylacrylic acid, vinylacetic acid, allylacetic acid, ethylidineacetic acid, propylidineacetic acid, crotonic acid, acryloxypropionic acid and alkali and metal salts thereof. Suitable unsaturated dicarboxylic acid monomers include, for example, maleic acid, maleic anhydride, fumaric acid, itaconic acid, citraconic acid, mesaconic acid, or methylenemalonic acid. Methacrylic acid (MAA) is a preferred ethylenically unsaturated carboxylic acid.

Other unsaturated monomers that, when used, are can be copolymerized with one or more of the foregoing alkyl (meth)acrylates include, without limitation, butadiene, acrylonitrile, methacrylonitrile, crotononitrile, alpha-chloroacrylonitrile, ethyl vinyl ether, isopropyl vinyl ether, isobutyl vinyl ether, butyl vinyl ether, diethylene glycol vinyl ether, decyl vinyl ether, ethylene, methyl vinyl thioether and propyl vinyl thioether, esters of vinyl alcohol, and combinations thereof.

In some embodiments, the polymer binder is an aqueous dispersion of polymer units derived from, based on the weight of the polymer: i) from 90 to 99.9 weight percent of at least one ethylenically unsaturated monomer not including component ii; and ii) from 0.1 to 10 weight percent of (meth)acrylamide. In some embodiments, the monomer of i) comprises a (C₁-C₂₀)alkyl (meth)acrylate ester in combination with a vinyl aromatic monomer. In some embodiments, i) is butyl acrylate in combination with styrene. In some embodiments, the amount of butyl acrylate in such combination may be from 5 to 90 weight percent and the amount of styrene may be from 95 to 10 weight percent based on the total weight of the butyl acrylate and styrene.

In some embodiments of the invention, the polymer binder is an aqueous dispersion of polymer units derived from: butyl acrylate, styrene, and acrylamide.

As described herein and, for example, in U.S. patent application Ser. No. 15/073,840, filed Mar. 18, 2016, and PCT Application No. PCT/US2016/032104, filed May 12, 2016, each of which is incorporated by reference in its entirety, the particle can be prepared by, for example, blending in a mixer with mechanical agitation the particle and the aqueous coating composition; or by spraying the aqueous coating composition onto a moving bed or a falling stream of the particles. The other methods for coating particles as described herein can also be used. In some embodiments, the amounts, based on the weight of the polymer are: from 65 to 75 weight percent of butyl acrylate; from 23 to 33 weight percent of styrene; and from 0.5 to 6 weight percent of acrylamide. In some embodiments, the amounts, based on the weight of the polymer are: from 69 to 71 weight percent of butyl acrylate; from 27 to 29 weight percent of styrene; and from 1 to 3 weight percent of acrylamide.

In some embodiments, the polymer binder is an aqueous dispersion of polymer units derived from: butyl acrylate, styrene, hydroxyethyl methacrylate, and acrylamide. Preferably, the amounts, based on the weight of the polymer are: from 65 to 75 weight percent of butyl acrylate; from 24 to 32 weight percent of styrene; from 0.25 to 2 weight percent hydroxyethyl methacrylate; and from 0.5 to 6 weight percent of acrylamide. In some embodiments, the amounts, based on the weight of the polymer are: from 69 to 71 weight percent of butyl acrylate; from 26 to 28 weight percent of styrene; from 0.25 to 0.75 weight percent hydroxyethyl methacrylate; and from 1 to 3 weight percent of acrylamide.

In some embodiments, the polymer binder is an aqueous dispersion of polymer units derived from, based on the weight of the polymer: i) from 80 to 99.9 weight percent of at least one ethylenically unsaturated monomer not including component ii); and ii) from 0.1 to 20 weight percent of a carboxylic acid monomer. Suitable carboxylic acid monomers include those described above. Methacrylic acid (MAA) is preferred.

In some embodiments, the polymer binder used is a metal-crosslinked emulsion copolymer, such as those described in U.S. Pat. Nos. 4,150,005, 4,517,330, and U.S. Pre-Grant publications 2011/0118409, and 2011/0230612, each of which is incorporated herein by reference. Suitable metal crosslinked film-forming emulsion (co)polymers comprise polymer units derived from one or more ethylenically unsaturated monomers and one or more acid functionalized monomers reacted with a polyvalent metal compound at a temperature above or below the Tg of the acid functionalized polymer to produce a crosslinked polymer.

In some embodiments, the metal-crosslinked copolymer is derived from, based on the weight of the copolymer: i) from 75 to 99 weight percent of at least one ethylenically unsaturated monomer not including component ii; and ii) from 1 to 25 weight percent of an ethylenically unsaturated carboxylic acid monomer stabilized with a polyvalent metal. In some embodiments, the monomer of i) comprises one or more (C₁-C₂₀)alkyl (meth)acrylate esters. In some embodiments, the monomer of i) comprises one or more (C₁-C₂₀)alkyl (meth)acrylate esters optionally in combination with a vinyl aromatic monomer. In some embodiments, i) is butyl acrylate, methylmethacrylate, and styrene. In some embodiments, the amount of butyl acrylate in such combination is from 1 to 80, the amount of methylmethacrylate is from 5 to 70, and the amount of styrene is from 0 to 70 weight percent based on the total weight of the butyl acrylate, methylmethacrylate and styrene.

Suitable carboxylic acid monomers for the foregoing embodiments include, without limitation, those described above. In some embodiments, it is methacrylic acid (MAA).

The polyvalent metal crosslinker employed in the foregoing embodiments is generally in the form of a polyvalent metal complex containing the polyvalent metal moiety, an organic ligand moiety and, if the crosslinker is added as a chelate to the formulation in solubilized form, an alkaline moiety. The polyvalent metal ion may be that of beryllium, cadmium, copper, calcium, magnesium, zinc, zirconium, barium, aluminum, bismuth, antimony, lead, cobalt, iron, nickel or any other polyvalent metal which can be added to the composition by means of an oxide, hydroxide, or basic, acidic or neutral salt which has an appreciable solubility in water, such as at least about 1% by weight therein. The alkaline moiety may be provided by ammonia or an amine. The organic ligand may be ammonia or an amine or an organic bidentate amino acid. The amino acid bidentate ligand is can be an aliphatic amino acid, but may also be a heterocyclic amino acid. Examples of polyvalent metal complexes include, but are not limited to, the diammonium zinc (II) and tetra-ammonium zinc (II) ions, cadmium glycinate, nickel glycinate, zinc glycinate, zirconium glycinate, zinc alanate, copper beta-alanate, zinc beta-alanate, zinc valanate, and copper bisdimethylamino acetate.

The amount of polyvalent metal compound added can be from about 15% to 100% of the equivalent of the acid residues of the copolymer emulsion, and may be at least about 15%. In some embodiments, the amount of the polyvalent metal ionic crosslinking agent is from about 35% to 80% of the equivalent of the acid residues of the copolymer emulsion. In some embodiments, the amount of the polyvalent metal crosslinking agent is from about 40% to 70% of the equivalent of the acid residues.

In some embodiments, the metal-crosslinked copolymer is derived from butyl acrylate, methyl methacrylate, styrene, hydroxy ethyl methacrylate, acrylic acid, and methacrylic acid, crosslinked with zinc ion. In some embodiments, the amounts, based on the 30 weight of the copolymer, are: from 28 to 40 weight percent butyl acrylate, from 5 to 20 weight percent methyl methacrylate, from 35 to 45 weight percent styrene, from 1 to 10 weight percent hydroxy ethyl methacrylate, from 1 to 10 weight percent acrylic acid and from 1 to 10 weight percent methacrylic acid, crosslinked with zinc ion. In some embodiments, the amounts, based on the weight of the copolymer, are: from 29 to 31 weight percent butyl aerylate, from 15 to 17 weight percent methyl methacrylate, from 39 to 41 weight percent styrene, from 4 to 6 weight percent hydroxy ethyl methacrylate, from 4 to 6 weight percent acrylic acid and from 4 to 6 weight percent methacrylic acid, crosslinked with zinc ion (about 0.9 equivalents).

In some embodiments, the polymer binder is a copolymer of a vinyl aromatic monomer such as styrene, a-methyl styrene, p-methyl styrene, or t-butylstyrene and a diene monomer, such as butadiene or isoprene. In some embodiments, such binders are copolymers of styrene and butadiene. In some embodiments, the weight ratio of styrene to butadiene in the 10 copolymer ranges from 70:30 to 30:70.

The balance of the aqueous compositions, containing surfactant, water, polymer

binder, optional poly(ethylene oxide), and any optional ingredients or co-solvents, is water. In some embodiments, the amount of water in the aqueous coating composition is 20 weight percent or less, alternatively 18 weight percent or less, or alternatively 16 weight percent or less, based on the total weight of the coating composition. In some embodiments, the amount of water in the aqueous coating composition is 5 weight percent or more, alternatively 10 weight percent or more, or alternatively 15 weight percent or more, based on the total weight of the coating composition.

Methods for preparation of water insoluble polymer binders suitable for use in the composition are known in the art and not especially limited. The preparation method may be selected from solution, dispersion and emulsion polymerization processes. Processes are also described in WO2015/073292, which is hereby incorporated by reference in its entirety.

In some embodiments, the polymer binder is present in the aqueous coating composition at a concentration of from 1 to 35 weight percent, from 5 to 20 weight percent, based on the total weight of the aqueous composition (including optional ingredients as described herein).

In some embodiments, the hydrophobic polymer is cured. Curing can be performed by many different methods and chemistries. Examples of such curing chemistries include, but are not limited to what is referred to as “Fenton's chemistry” (i.e., wet oxidation using hydrogen peroxide and iron salts, persulfates chemistry, azobisisobutyronitrile initiated curing. Other curing agents, include, but are not limited to, benzoyl peroxide, dicumyl peroxide, and more soluble persulfate compounds such as ammonium or sodium salts that can be used as well, alone or in combination with drying salts, such as, but not limited to, zirconium 2-ethylhexanoate, cobalt 2-ethylhexanoate, cobalt naphthanate, manganese chloride, or manganese acetate. The above can be used in any combination with one another.

Curing can also be performed using sulfur. For example, sulfur curing can be performed with sulfur alone, or with activators (activators increase the efficiency of the crosslinking reaction). Activators include, but are not limited to, sulfonamides. Sulfonamide curing can be accelerated through the use of accelerators (Accelerators increase the rate of reaction, not necessarily the efficiency of the reaction). In some embodiments, accelerators are often a combination of a metal oxide and a fatty acid, including but not limited to a zinc oxide/stearic acid combination. Zincdialkyldithiocarbamates can also be used as accelerators, without the need for an activator because the Zn is incorporated in the accelerator. These are only a few examples of possible chemistries known in the art for vulcanization, activators, and accelerants. Other variants are listed in Odian, Principles of Polymerization 3^{rd} edition p 700-707, can also be used, which is hereby incorporated by reference, as well as others known in the art. These other crosslinking variants could be used to cure the hydrophobic polymer. In some embodiments, other curing techniques can be used to cure the hydrophobic polymer, including plasma surface treatment, electron beam curing, UV curing, or crosslinking initiation via use of ionic species, and the like.

The polymer can also be cured using a metal, which can accelerate the rate of curing, which can also be referred to as “drying.” Such metals can also be referred to as “drying agents.” Examples of drying agents include, but are not limited to, cobalt, manganese, iron, cerium, vanadium, lead, zirconium, bismuth, barium, aluminium, strontium, calcium, zinc, lithium, potassium, or any combination thereof. Metal salts of these metals can also be used as a drying agent. For example, the metals are often present as metal salts with the ethylhexanoate anion. Without being bound to any specific theory, the use of ethylhexanoate or other organic anions help improve miscibility of the metal salt with the polymer phase of an emulsion. Use of multiple drier chemicals can often yield a significant improvement over single drier species use. Accordingly, metal oxides, metal salts, and metal compounds can be used to cure the hydrophobic polymer.
In some embodiments, a coagent is used in the curing reaction. Coagents can also be referred to “reactive diluents.” The coagents have unsaturated groups that can participate in the crosslinking and accelerate both curing rate and overall degree of crosslinking. Examples of coagents, include, but are not limited to, high vinyl polybutadienes, and polymers, oligomers thereof, or small molecules that contain maleate, vinyl, ethynyl or acetylinic moieties, with, in some embodiments, functionality greater than or equal to 2. In some embodiments, these coagents (reactive diluents) remain a part of the hydrophobic polymer network, and the coating on the particle, after curing has taken place. Examples of coagents are described in Vanderbilt Rubber Handbook, 13th Edition, which is incorporated by reference in its entirety, and for example, pp 88-91, which is also specifically incorporated by reference. Examples of coagents also include those in the following table:

| Trade Name | Description |
|---|---|
| SR 297 (BGDMA) | Difunctional Liquid Methacrylate |
| SR 350 (TMPTMA) | Trifunctional Liquid Methacrylate |
| Saret ® SR 516 | Scorch-Retarded Liquid Dimethacrylate |
| Saret SR 517 | Scorch-Retarded Liquid Trimethacrylate |
| Saret SR 519 | Scorch-Retarded Liquid Triacrylate |
| Saret SR 521 | Scorch-Retarded Liquid Dimethacrylate |
| Saret SR 522 | Scorch-Retarded Solid Diacrylate |
| Saret SR 633 | Scorch-Retarded Metallic Diacrylate |
| Saret 75 EPM 2A (75% active) | |
| Saret SR 634 | Scorch-Retarded Metalic Dimethacrylate |
| Saret 75 EPM 2A (75% active) | |
| VANLINK ™ TAC Coagent | Triallyl Cyanurate |
| VANAX ®MBM Accelerator | Bis-maleimide |
| Ricon ® 100 | Styrene/Butadiene Copolymer (70% vinyl) |
| Ricon 153 | 85% Vinyl Liquid Polybutadiene |
| Ricon 153 D (65% active) | |
| Ricon 154 | 90% Vinyl Liquid Polybutadiene |
| Ricon 154 D (65% active) | |
| Ricobond ® 1731 | Maleinized Liquid Polybutadiene (28% vinyl) |
| Ricobond 1731 HS (69% active) | |
| Ricobond 1756 | Maleinized Liquid Polybutadiene (70% vinyl) |
| Ricobond 1756 HS (69.5% active) | |

The polymer can be cured prior to coating the sand (proppant), after coating the sand, at the same time. Any method of curing can be used, such as those described in the Examples. The Examples can be modified by increasing or decreasing the temperature or by increasing or decreasing the amount of time that the polymer is allowed to cure.

Accordingly, in some embodiments, a hydrophobic coated particle is prepared by contacting a cured and/or curable hydrophobic polymer with a particle (e.g. sand, proppant, and the like). The polymer can be completely cured or substantially cured. The hydrophobic polymer can be allowed to cure for about 1 to about 10 minutes, about 1, about 2, about 3, about 4, about 5, about 6, about 7, about 8, about 9, or about 10 minutes or any range in between. In some embodiments, the hydrophobic polymer that has been cured is contacted with the particle to coat the particle in an emulsion. In some embodiments, the cured and/or curable hydrobphobic polymer is a cured and/or curable polybutadiene.

In some embodiments, the hydrophobic polymer is cured by contacting the polymer with iron or a salt thereof (e.g. ferrous sulfate) and a radical initiator (e.g. hydrogen peroxide) in an amount sufficient cure the polymer. In some embodiments, the hydrophobic polymer is cured by contacting the polymer with potassium persulfate in water in an amount sufficient to cure the polymer. In some embodiments, the hydrophobic polymer is cured by contacting the polymer with azobisisobutylnitrile in an amount sufficient to cure the polymer. In some embodiments, the curing occurs at room temperature. In some embodiments, In some embodiments, the curing occurs at a temperature of about 15 to about 25 C, about 18 to about 25 C, or about 20 to about 25 C. As described herein, in some embodiments, the hydrophobic polymer is a polybutadiene. In some embodiments, the polybutadiene is a non-functionalized polybutadiene, a maleic anhydride functionalized polybutadiene, a hydroxyl-amine, amide, keto, aldehyde, carboxyl, mercaptan, epoxy, alkoxy silane, alkoxy, azide, halide terminated polybutadiene or any combination thereof.

In some embodiments, the hydrophobic polymer is crosslinked by contacting the polymer with a radical initiator. Examples of radical initiators are described herein and include, but are not limited to, AIBN and peroxides (e.g. dicumyl peroxide), and ferrous sulfate initiators. The polymer can be contacted with the radical initiator in an amount sufficient to crosslink the polymer. In some embodiments, the hydrophobic polymer is crosslinked by contacting the polymer with azobisisobutylnitrile in an amount sufficient to cure the polymer. In some embodiments, the hydrophobic polymer is crosslinked by contacting the polymer with a peroxide in an amount sufficient to cure the polymer. In some embodiments, the hydrophobic polymer is crosslinked by contacting the polymer with ferrous sulfate (e.g. ferrous sulfate heptahydrate) in an amount sufficient to cure the polymer. In some embodiments, the crosslinking occurs at room temperature. In some embodiments, In some embodiments, the crosslinking occurs at a temperature of about 15 to about 25 C, about 18 to about 25 C, or about 20 to about 25 C. As described herein, in some embodiments, the hydrophobic polymer that is crosslinked is a polyalphaolefin, such as those described herein.

The cured or crosslinked polymer can then be contacted (e.g. mixed or sprayed as described herein) with the particle (e.g. sand) to coat the particle. The coated particle is considered to be a hydrophobic coated particle. The coating can take place using particles (e.g., sand) at an elevated temperature, such as at a temperature of about 150 to about 300 F, about 200 to about 300 F, about 225 to about 275 F, about 235 to about 265 F, about 200 F, about 210 F, about 220 F, about 230 F, about 240 F, about 250 F, or about 260 F. The particle can be allowed to cool before use. The cooling and curing, can for example take place while the particle is in storage or in transit to a well site or other location. In some embodiments, the hydrophobic polymer is a polybutadiene, or poly-isoprene or chloroprene. In another embodiments, the hydrophobic polymer may be a di or tri or ter-block polymers or a combination that are terminated with hydroxyl, amine, amide, keto, aldehyde, mercaptan, carboxylic, epoxy, halide, azide, alkoxy silane functionality. Examples of such diblock and triblock or terblock polymers backbone are not limited to styrene butadiene, acrylonitrile butadiene styrene, acrylonitrile butadiene, ethylene-acrylate rubber, polyacrylate rubber, isobutylene isoprene butyl, styrene ethylene butylene styrene copolymer, styrene butadiene carboxy block copolymer, chloro isobutylene isoprene, ethylene-acrylate rubber, styrene-acrylonitrile, polystyrene)-block-(polyisoprene) poly(ethylene-vinyl acetate)_polyethyleneglycol-polylactic acid, polyethyleneglycol-polylactide-co-glycolide, polystyrene-co-poly(methyl methacrylate), poly(styrene-block-maleic anhydride), Poly(styrene)-block-poly(acrylic acid), Poly(styrene-co-methacrylic acid, poly(styrene-co-α-methylstyrene), poly(ε-caprolactone)-poly(ethylene glycol), styrene-isoprene-styrene.

In some embodiments, the particle is heated before being contacted with a coating or material described herein. The particle can be, in some embodiments, heated before being contacted, mixed, or sprayed with any coating or agent described herein. In some embodiments, the particle is heated to a temperature of about 150 to about 300 F, about 200 to about 300 F, about 225 to about 275 F, about 235 to about 265 F, about 200 F, about 210 F, about 220 F, about 230 F, about 240 F, about 250 F, or about 260 F. In some embodiments, the particle is not heated or is at a temperature of about 60 to about 80 F before being contacted with a coating or material described herein. In some embodiments, the particle is at a temperature of about 70 to about 80 F, about 70 to about 75 F, about 75 to about 80 F.

In some embodiments, the hydrophobic coated particle is free of a compatibilizing agent. In some embodiments, the hydrophobic coated particle is free of a compatibilizing agent, coupling agent, a silane and/or a siloxane.

In some embodiments, the coated particulates and/or proppants described herein are substantially free, or free, of an agent that is acting as a frother. An agent is acting as a frother if the agent increases the surface tension (bubble strength) of air bubbles in solution. However, the agent should be added with the intent of acting as a frother. Thus, although a surfactant may in some instances act as a frother, it can also act independently as a compatibilizing agent for attachment of the hydrophobic polymer to the particles. A small amount of surfactant may also be added to initially reduce the possibility of formation of bubbles or plastrons on particles when first exposed to water, but prior to introduction into a blender for hydraulic fracturing slurry preparation, so as to avoid snaking and possible cavitation and blender or pump damage. In this case the frothers do not need to be alcohols. In some embodiments, the coated particulates and/or proppants contain less than 5%, 4%, 3%, 2%, 1%, 0.9%, 0.8%, 0.7%, 0.6%, 0.5%, 0.4%, 0.3%, 0.2%, or 0.1% of a frother by wt %.

In some embodiments, the % wt of the hydrophobic polymer is greater than 0% wt of the particulate or proppant, but less than or equal to 0.5% wt of the particulate or proppant, less than or equal to 0.4% wt of the particulate or proppant, less than or equal to 0.3% wt of the particulate or proppant, or less than or equal to 0.2% wt of the particulate or proppant. In some embodiments, the % wt of the hydrophobic polymer is about 0.01% wt to about 1% wt, about 0.2% wt to about 1% wt, about 0.3% to about 1%, about 0.4% to about 1%, about 0.5% to about 1%, 0.01% wt to about 0.9% wt, about 0.2% wt to about 0.9% wt, about 0.3% wt to about 0.9% wt, about 0.4% wt to about 0.9% wt, about 0.5% wt to about 0.9% wt, 0.01% wt to about 0.8% wt, about 0.2% wt to about 0.8% wt, about 0.3% wt to about 0.8% wt, about 0.4% wt to about 0.8% wt, about 0.5% wt to about 0.8% wt, 0.01% wt to about 0.7% wt, about 0.2% wt to about 0.7% wt, about 0.3% wt to about 0.7% wt, about 0.4% wt to about 0.7% wt, about 0.5% wt to about 0.7% wt, 0.01% wt to about 0.6% wt, about 0.2% wt to about 0.6% wt, about 0.3% wt to about 0.6% wt, about 0.4% wt to about 0.6% wt, about 0.5% wt to about 0.6% wt, 0.01% wt to about 0.5% wt, about 0.2% wt to about 0.5% wt, about 0.3% wt to about 0.5% wt, about 0.4% wt to about 0.5% wt, 0.01% wt to about 0.4% wt, about 0.2% wt to about 0.4% wt, about 0.3% wt to about 0.4% wt, 0.01% wt to about 0.3% wt, about 0.2% wt to about 0.3% wt, 0.01% wt to about 0.2%, 0.01% wt to about 0.1% of the particulate or proppant. Other % wt are provided herein and the hydrophobic polymer can also be in those proportions as well.

In some embodiments, the coating is present in similar % wt amounts. Accordingly, in some embodiments, the % wt of the coating is greater than 0% wt of the particulate or proppant, but less than or equal to 0.5% wt of the particulate or proppant, less than or equal to 0.4% wt of the particulate or proppant, less than or equal to 0.3% wt of the particulate or proppant, or less than or equal to 0.2% wt of the particulate or proppant. In some embodiments, the % wt of the coating is about 0.01% wt to about 1% wt, about 0.2% wt to about 1% wt, about 0.3% to about 1%, about 0.4% to about 1%, about 0.5% to about 1%, 0.01% wt to about 0.9% wt, about 0.2% wt to about 0.9% wt, about 0.3% wt to about 0.9% wt, about 0.4% wt to about 0.9% wt, about 0.5% wt to about 0.9% wt, 0.01% wt to about 0.8% wt, about 0.2% wt to about 0.8% wt, about 0.3% wt to about 0.8% wt, about 0.4% wt to about 0.8% wt, about 0.5% wt to about 0.8% wt, 0.01% wt to about 0.7% wt, about 0.2% wt to about 0.7% wt, about 0.3% wt to about 0.7% wt, about 0.4% wt to about 0.7% wt, about 0.5% wt to about 0.7% wt, 0.01% wt to about 0.6% wt, about 0.2% wt to about 0.6% wt, about 0.3% wt to about 0.6% wt, about 0.4% wt to about 0.6% wt, about 0.5% wt to about 0.6% wt, 0.01% wt to about 0.5% wt, about 0.2% wt to about 0.5% wt, about 0.3% wt to about 0.5% wt, about 0.4% wt to about 0.5% wt, 0.01% wt to about 0.4% wt, about 0.2% wt to about 0.4% wt, about 0.3% wt to about 0.4% wt, 0.01% wt to about 0.3% wt, about 0.2% wt to about 0.3% wt, 0.01% wt to about 0.2%, 0.01% wt to about 0.1% of the particulate or proppant. Other % wt are provided herein and the coating can also be in those proportions as well.

In some embodiments, the coated particulates (proppant solids) are substantially free or completely free of hydrogels. For the avoidance of doubt, embodiments provided herein can provide with coated proppants or particulates that include hydrogels or are substantially free or completely free of hydrogels regardless of where they are described herein. In some embodiments, the coated particulates contain less than 5%, 4%, 3%, 2%, 1%, 0.9%, 0.8%, 0.7%, 0.6%, 0.5%, 0.4%, 0.3%, 0.2%, or 0.1% of a hydrogel by wt %.

Various processes are described herein for adding coatings. Such processes can be used or modified to add the coatings and materials described herein. For example, the sprayers described below can be used to apply the coating comprising the compatibilizing agent and the hydrophobic polymer. The coatings can also be applied according to other resin coating methods, such as those described in U.S. Provisional Application No. 62/072,479 filed Oct. 30, 2014 and U.S. Provisional Application No. 62/134,058, filed Mar. 17, 2015, U.S. patent application Ser. No. 14/928,379, filed Oct. 30, 2015, and PCT Application No. PCT/US2015/058313, filed Oct. 30, 2015, each of which are hereby incorporated by reference in its entirety. For example, in some embodiments, the coatings can be applied using mixers, where the particles and the coatings, either component by component or simultaneously are mixed in mixers and then discharged from the mixers. The mixing can be done at the temperatures described herein. The particles can also be heated as described herein prior to being added to the mixer or once added to the mixer.

In some embodiments, process for preparing coated particulates are provided. In some embodiments, the coated particulate comprises a particulate core coated with a compatibilizing agent and a hydrophobic polymer. In some embodiments, the process comprises contacting the particulate core with the compatibilizing agent and the hydrophobic polymer under conditions sufficient to coat the particulate core to produce the coated particulate. The compatibilizing agent and the hydrophobic polymer can be contacted (mixed, baked, sprayed, adsorbed onto, etc. . . . ) simultaneously or sequentially. In some embodiments, the core is contacted initially with the compatibilizing agent followed by the hydrophobic polymer. In some embodiments, the core is contacted initially with the hydrophobic polymer followed by the compatibilizing agent. In some embodiments, the core is contacted with the compatibilizing agent for a period of time by itself and then together with the hydrophobic polymer.

In some embodiments, the coated particulate comprises a particulate core coated with a hydrophobic polymer or cured and/or curable hydrophobic polymer. As described herein and above, the polymer can be cured before or after is coated onto the particulate core. In some embodiments, the process comprises contacting the particulate core with the hydrophobic polymer under conditions sufficient to coat the particulate core to produce the coated particulate. In some embodiments, the process comprises contacting the particulate core with the hydrophobic polymer with a curing agent under conditions sufficient to coat the particulate core with a cured and/or curable hydrophobic polymer to produce the coated particulate. The hydrophobic polymer and curing agent can be contacted (mixed, baked, sprayed, adsorbed onto, etc. . . . ) simultaneously or sequentially. Examples of processes of coating a particulate core with a hydrophobic polymer, including a cured and/or curable hydrophobic polymer, are described herein.

As described herein, particulates (proppants) can be contacted with various treatment agents. In some embodiments, the treatment agent comprises the compatibilizing agent. In some embodiments, the treatment agent comprises the hydrophobic polymer. In some embodiments, the treatment agent comprises the cured and/or curable hydrophobic polymer. In some embodiments, the treatment agent comprises the compatibilizing agent and the hydrophobic polymer and/or the curable hydrophobic polymer. The treatment agents can be applied sequentially or simultaneously. For example, in some embodiments, the particulate core is contacted with a first treatment agent comprising a compatibilizing agent and a second treatment agent comprising a hydrophobic polymer or cured and/or curable hydrophobic polymer. In another non-limiting example, the particulate core is contacted with the first treatment agent and the second treatment agent simultaneously. In some embodiments, the particulate core is contacted with the first treatment agent and the second treatment agent sequentially. In some embodiments, a particulate core is not contacted with a compatibilizing agent.

The processes provided herein, therefore, provide a process that comprises coating a particulate core with a compatibilizing agent to produce a particulate coated with the compatibilizing agent; and coating the particulate coated with the compatibilizing agent with a hydrophobic polymer and/or a cured and/or curable hydrophobic polymer. In some embodiments, the compatibilizing agent encapsulates the particulate core and a first surface of the hydrophobic polymer binds to the compatibilizing agent and a second surface of the hydrophobic polymer is exposed to provide an exposed hydrophobic surface of the coated particulate. The hydrophobic polymer can be a cured and/or curable hydrophobic polymer. The hydrophobic polymer can also be a polymer that can be crosslinked. Examples of these include, but are not limited to the polybutadienes and polyalphaolefins described herein.

The processes can be used to produce a coated particulate that has enhanced particulate transport as compared to a particulate without the exposed hydrophobic surface.

The compatibilizing agent and/or hydrophobic polymers can be any agent that is suitable, such as, but not limited to, those described herein.

In some embodiments of the process provided herein, the compatibilizing agent is contacted with the particulate core at a temperature of about 20-25 C. In some embodiments, the hydrophobic polymer is contacted with the particulate core at a temperature of about 20-25 C. In some embodiments, the compatibilizing agent is contacted with the particulate core at a temperature of at least 100 C. In some embodiments, the hydrophobic polymer is contacted with the particulate core at a temperature of at least 100 C.

In some embodiments, the method for the producing the coated particulates can be implemented without the use of solvents. Accordingly, the mixture obtained in the formulation process is solvent-free, or is essentially solvent-free. The mixture is essentially solvent-free, if it contains less than 20 wt %, less than 10 wt %, less than 5 wt %, less than 3 wt %, or less than 1 wt % of solvent, relative to the total mass of components of the mixture.

In some embodiments, during the formulation process, the proppant is heated to an elevated temperature and then contacted with the coating components. In some embodiments, the proppant is heated to a temperature from about 50° C. to about 150° C. to accelerate the coating of the particulate.

In addition to the systems described herein, a mixer can be used for the coating process and is not particularly restricted and can be selected from among the mixers known in the specific field. For example, a pug mill mixer or an agitation mixer can be used. For example, a drum mixer, a plate-type mixer, a tubular mixer, a trough mixer or a conical mixer can be used. In some embodiments, the mixing is performed in a rotating drum although a continuous mixer or a worm gear can also be used for a period of time within the range of 1-6 minutes, or a period of 2-4 minutes during which the coating components are combined and simultaneously reacted on the proppant solids within the mixer while the proppant solids are in motion.

Mixing can also be carried out on a continuous or discontinuous basis. In suitable mixers it is possible, for example, to add the agents continuously to the heated proppants. For example, the compatibility agent and/or the hydrophobic polymer can be mixed with the particulates in a continuous mixer (such as a worm gear or a high speed paddle blade continuous mixer) in one or more steps to make one or more layers of the coating. In some embodiments, the coating residence time is from about 1 to about 20 seconds. In some embodiments, the coating residence time is from about 2 to about 20, about 3 to about 20, about 5 to about 20, about 6 to about 20, about 7 to about 20, about 8 to about 20, about 9 to about 20, about 10 to about 20, about 15 to about 20, about 2 to about 15, about 2 to about 10, about 2 to about 5, about 3 to about 15, about 3 to about 10, about 3 to about 5, about 4 to about 15, about 4 to about 10, about 4 to about 5, about 5 to about 15, or about 5 to about 10 seconds.

The temperature can be modified or restricted as described herein. Additionally, in some embodiments, the coating step is performed at a temperature of from about 10° C. to about 200° C., from about 10° C. to about 150° C., from about 20° C. to about 200° C., from about 20° C. to about 150° C., from about 30° C. to about 200° C., from about 30° C. to about 150° C., from about 40° C. to about 200° C., from about 40° C. to about 150° C., from about 50° C. to about 200° C., from about 50° C. to about 150° C., from about 60° C. to about 200° C., from about 60° C. to about 150° C., from about 70° C. to about 200° C., from about 70° C. to about 150° C., from about 80° C. to about 200° C., from about 80° C. to about 150° C., from about 90° C. to about 200° C., from about 90° C. to about 150° C., from about 1000° C. to about 200° C., or from about 100° C. to about 150° C. In some embodiments, it is the particulate that is at the temperature. In some embodiments, the reaction (contacting/mixing) is at the temperature. Other temperatures can also be used as described herein.

In some embodiments, the agents may be applied in more than one layer. In some embodiments, the coating process is repeated as necessary (e.g. 1-5 times, 2-4 times or 2-3 times) to obtain the desired coating thickness. In some embodiments, the thickness of the coating of the particulate can be adjusted and used as either a relatively narrow range of coated particulate size or blended with proppants of other sizes, such as those with more or less numbers of coating layers of the compositions described herein, so as to form a coated particulate blend have more than one range of size distribution. In some embodiments, a range for coated particulate is about 20-70 mesh.

In some embodiments, the coated proppants can be baked or heated for a period of time. In some embodiments, baking or heating step is performed like a baking step at a temperature from about 100°−200° C. for a time of about 0.5-12 hours or at a temperature from about 125°-175° C. for 0.25-2 hours. In some embodiments, the coated particulate is cured for a time and under conditions sufficient to produce a coated particulate that exhibits a loss of coating of less than 25 wt %, less than 15 wt %, or less than 5 wt % when tested according to ISO 13503-5:2006(E).

In addition to the agents or components described herein, the coated particulate can be coated in a solution that comprises an antifreezing agent. Freezing of proppants in a transport vehicle (e.g. train, truck, car, and the like) can be a problem when temperatures are below or near freezing of the temperature of water. Therefore, in some embodiments, to avoid the freezing effect or the risk of freezing the materials described herein are added in a composition (e.g. solution) comprising an antifreeze agent. Examples of an antifreeze agent include, but are not limited to, propylene glycol, methanol, ethanol, sodium chloride, potassium chloride, ethylene glycol, glycerol, or any combination thereof, and the like. In some embodiments, however, the coating does not comprise, or is free of, an antifreezing agent.

Additionally, the coatings described herein can be applied with a tracer to monitor the coating. Due to the very low levels of coating applied to produce some coated particulate cores (0.1 to 0.5% solids applied to sand), it can be difficult to differentiate between coated particulates and uncoated particulates by visual inspection. It can also be difficult to judge the coating efficiency of a coating process when one cannot accurately measure coating thicknesses or coverage areas. Therefore, to overcome these difficulties a tracer that can be detected can be used. Examples include, but are not limited to, fluorescent dyes. In some embodiments, the tracer can be coated onto the particulate core with the compatibilizing agent and the hydrophobic polymer to coat the particulate core. The tracer can be in the same solution as the compatibilizing agent and/or the hydrophobic polymer or it can be in a different solution but it applied at the same time or essentially the same time.

As described herein, agents can be applied to the particulates in a short amount of time. The same can time limits can be applied to the application of the compatibilizing agents and/or the hydrophobic polymers to the particulates. For example, in some embodiments, the compatibilizing agent is contacted with the particulates for about less than five, four, three, or two seconds. In some embodiments, the hydrophobic polymer is contacted with the particulates for about less than five, four, three, or two seconds.

In some embodiments, the particulates are contacted more than once with the hydrophobic polymer, cured or curable hydrophobic polymer and/or compatibilizing agent.

As described herein for other process, in some embodiments, the contacting comprises spraying said compatibilizing agent and/or hydrophobic agent onto said particulate core while said particulate core is in free fall, guided free fall, or during pneumatic transport. In some embodiments, the particulate is contacted with the compatibilizing agent and/or the hydrophobic polymer for the time it takes said particulate to fall a distance of four feet by gravity.

In some embodiments, the contacting comprises spraying said particulates substantially simultaneously from more than one direction. They can be sprayed with one or more treatment agents. The treatment agents can contain the same components or different components. For example, in some embodiments, each of the treatment agents comprises both the compatibilizing agent and the hydrophobic polymer. However, in some embodiments, one agent comprises the compatibilizing agent and another agent comprises the hydrophobic polymer. Thus, just as in other embodiments, the components can be applied to the particulates separately in different or the same compositions (e.g. solutions).

In some embodiments, coated particulates are provided, wherein the coating is a mixture of 1) an alkoxylate or an alkoxylated alcohol, 2) an acrylic polymer, and 3) an amorphous polyalphaolefin. In some embodiments, the coating comprises a plurality of alkoxylated alcohols. In some embodiments, the coating comprises a plurality of different alkoxylated alcohols. In some embodiments, the coating does not comprise an alkoxylate. As described herein, the coating can be free of a hydrogel or comprise a hydrogel as described herein. In some embodiments, the coating is free of a frother, however, in some embodiments, it can also comprise a frother. In some embodiments, the coating further comprises fumed silica. The alkoxylate can have a formula of Formula I, II, III, IV, or V as described herein.

In some embodiments, the acrylic polymer comprises an aqueous dispersion of particles made from a copolymer, based on the weight of the copolymer, comprising: i) from 90 to 99.9 weight percent of at least one ethylenically unsaturated monomer not including component ii; and ii) from 0.1 to 10 weight percent of (meth)acrylamide. In some embodiments, the acrylic polymer comprises an aqueous dispersion of particles made from a copolymer, based on the weight of the copolymer, comprising: i) from 80 to 99.9 weight percent of at least one ethylenically unsaturated monomer not including component ii; and ii) from 0.1 to 20 weight percent of a carboxylic acid monomer.

In some embodiments, the acrylic polymer comprises an aqueous dispersion of particles made from a copolymer, based on the weight of the copolymer, comprising: i) from 75 to 99 weight percent of at least one ethylenically unsaturated monomer not including component ii; ii) from 1 to 25 weight percent of an ethylenically unsaturated carboxylic acid monomer stabilized with a polyvalent metal. In some embodiments, the polyvalent metal is zinc or calcium.

In some embodiments, the ethylenically unsaturated carboxylic acid monomer is (meth)acrylic acid. In some embodiments, the acrylic polymer comprises a vinyl aromatic diene copolymer. In some embodiments, the polyalphaolefin is a crosslinked polyalphaolefin polymer. In some embodiments, the crosslinked polyalphaolefin polymer is a potassium persulfate crosslinked polyalphaolefin polymer, an azobisisobutylnitrile crosslinked polyalphaolefin polymer, or a ferrous sulfate-hydrogen peroxide crosslinked polyalphaolefin polymer.

In some embodiments, the coated particluates are prepare by a method. In some embodiments, the method comprises mixing the particulates with 1) an alkoxylate or an alkoxylated alcohol, 2) an acrylic polymer, and 3) an amorphous poly-alpha-olefin. In some embodiments, the methods further comprise mixing the particulate with fumed silica.

In some embodiments, the total weight of the alkoxylate or an alkoxylated alcohol and the acrylic polymer to the weight of the particulates is in a ratio of about 0.5:1000 to 1.25:1000. In some embodiments, the ratio is about 0.5:1000, about 0.6:1000, about 0.7:1000, about 0.8:1000, about 0.9:1000, about 1.0:1000, about 1.1:1000, about 1.2:1000, about 1.3:1000, about 1.4:1000, about 1.5:1000, about 1.6:1000, about 1.7:1000, about 1:8:1000, about 1.9:1000, or about 2.0:1000 (1:500). In some embodiments, as described herein the alkoxylate or an alkoxylated alcohol and the acrylic polymer is ROHMIN DC-5500.

In some embodiments, the total weight of the amorphous poly-alpha-olefin to the weight of the particulates is in a ratio of about 0.75:1000 to 3.00:1000. In some embodiments, the total weight of the amorphous poly-alpha-olefin to the weight of the particulates is in a ratio of about 1.75:1000 to 2.75:1000. In some embodiments, the total weight of the amorphous poly-alpha-olefin to the weight of the particulates is in a ratio of about 2.50:1000. In some embodiments, the ratio is about 0.5:1000, about 0.6:1000, about 0.7:1000, about 0.8:1000, about 0.9:1000, about 1.0:1000, about 1.1:1000, about 1.2:1000, about 1.3:1000, about 1.4:1000, about 1.5:1000, about 1.6:1000, about 1.7:1000, about 1:8:1000, about 1.9:1000, about 2.0:1000 (1:500), about 2.1:1000, about 2.2:1000, about 2.3:1000, about 2.4:1000, about 2.5:1000, about 2.6:1000, about 2.7:1000, about 2.8:1000, about 2.9:1000, or about 3.0:1000. As described herein, in some embodiments, the amorphous poly-alpha-olefin is VESTOPLAST® W-1750 (amorphous poly-alpha-olefins dispersion).

In some embodiments, the ratio of the fumed silica to the particulate is about 0.5:1000 to about 1.5:1000, about 0.75:1000 to about 1.25:1000, about 0.8:1000 to about 1.15:1000, about 0.9:1000 to about 1.1:1000, or about 1:5:1000 to about 2.0:1000(1:500). In some embodiments, the ratio of the fumed silica to the particulate is about 0.5:1000, about 0.6:1000, about 0.7:1000, about 0.8:1000, about 0.9:1000, about 1.0:1000, about 1.1:1000, about 1.2:1000, about 1.3:1000, about 1.4:1000, about 1.5:1000, about 1.6:1000, about 1.7:1000, about 1:8:1000, about 1.9:1000, or about 2.0:1000 (1:500).

In some embodiments, the method of coating the particulate comprises mixing the particulate with 1) the alkoxylate or the alkoxylated alcohol and 2) the acrylic polymer; and mixing the product with the amorphous poly-alpha-olefin to produce the coated particulate. In some embodiments, the method comprises mixing the particulate with 1) the alkoxylate or the alkoxylated alcohol and 2) the acrylic polymer; and mixing the product with the amorphous poly-alpha-olefin and fumed silica to produce the coated particulate. In some embodiments, the fumed silica is added to the particulate mixture before the amorphous poly-alpha-olefin is mixed with the sand.

In some embodiments, the method comprises mixing the particulate with 1) the alkoxylate or the alkoxylated alcohol and 2) the acrylic polymer, mixing the product with fumed silica, and then mixing the product with amorphous poly-alpha-olefin.

In some embodiments of the methods described herein, the methods further comprise mixing the product with a second amorphous poly-alpha-olefin to produce the coated particulate. In some embodiments, the second-amorphous poly-alpha-olefin is the same or different than the amorphous poly-alpha-olefin of the previous step(s).

In some embodiments, the particulates are pre-heated as described herein. In some embodiments, the chemicals are heated as described herein before being mixed. The particulates and the components can also be heated during the mixing at the temperatures described herein. In some embodiments, the methods are performed at a temperature of about 200 to about 300 F. In some embodiments, the methods are performed at a temperature of about 225 to about 275 F. In some embodiments, the method are performed at a temperature of about 240 to about 260 F.

In some embodiments, the particulates are mixed with the alkoxylate or the alkoxylated alcohol, the acrylic polymer, and the amorphous poly-alpha-olefin for about 30 to about 180 seconds.

In some embodiments, the alkoxylate or the alkoxylated alcohol, the acrylic polymer, and the amorphous poly-alpha-olefin are mixed before being contacted with the particle. In some embodiments, the components are mixed and are allowed to sit for about 12 hours before being mixed with the particles. The components can also be heated separately before being mixed. In some embodiments, the components are heated for up to 12 hours before being mixed and then coated the sand in a mixer as described herein.

In some embodiments, the process is performed without the use of an organic solvent for one or more of the mixing steps. In some embodiments, the process is performed completely without the use of an organic solvent. Without the use of an organic solvent can refer to a process where an organic solvent is not specifically used to assist coating the particulates. Traces of organic solvents that may be present on one of the components that is used to coat the sand does mean that an organic solvent is used in the process.

In some embodiments, the process comprises a drying step to remove any moisture.

In some embodiments, coated particulates are provided, wherein the coating comprises a mixture a polybutadiene and fumed silica. In some embodiments, the polybutadiene is a hydroxyl terminated polybutadiene. In some embodiments, the hydroxyl terminated polybutadiene has an average M_{w} of about 6,200 and/or an average Mₙ of about 2,800. In some embodiments, the hydroxyl terminated polybutadiene has a formula of

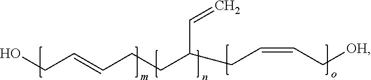

wherein m, n, and o are non-zero integers.

Hydroxyl-terminated polybutadiene oligomer reactant can be prepared, for example, as described in EP0690073A1, U.S. Pat. No. 5,043,484 and U.S. Pat. No. 5,159,123, each of which are hereby incorporated by reference in its entirety. These are non-limiting examples. The structure can be such that the hydroxyl groups are in predominantly primary, terminal positions on the main hydrocarbon chain and are allylic in configuration. In some embodiments, at least 1.8 hydroxyl groups are present per molecule on the average, and in some embodiments, there are at least from 2.1 to 3 or more hydroxyls per polymer molecule, for example, but not limited to, 2.1 to 2.8. The diene polymer has most of its unsaturation in the main hydrocarbon chain, such that m plus o in the formula above is greater than n. The formula should not be understood as implying that the polymers are necessarily in blocks, but that the cis-1,4; trans-1,4 and vinyl (1,2) unsaturation is usually distributed throughout the polymer molecule. This is true for all such formulae herein. The letter m may represent a number sufficient to give a trans-1,4 unsaturation content of 40-70 percent; n may be a number sufficient to give a 1,2-vinylic unsaturation content to the polymer in the range of 10-35 percent, while o may be sufficient to provide a cis-1,4-unsaturation of 10-30 percent, in some embodiments. In some embodiments, the polymer will contain largely trans-1,4-units, e.g. 50-65 percent and 15-25 percent cis-1,4-units, with 15-25 percent 1,2-units. Branching may also occur in the above polymers, especially those prepared at higher temperatures; ether and carbonyl linkages may appear in the lower molecular weight oligomer fractions. In some embodiments, the number average molecular weight of the oligomers of the formula is in the range of about 100 to about 20,000, and the hydroxyl (—OH) content of said products is in the range of 0.1 to 20 meq/g, or higher. In some embodiments, the number average molecular weight is in the range 200-5000 and the hydroxyl content is in the range of 0.05 to 10 meq/g. In some embodiments, polymer has an average Mw of about 6,200 and/or an average Mn of about 2,800.

In some embodiments, methods of preparing coated particulates are provided, wherein the methods comprise mixing a polybutadiene and fumed silica with the particulates to produce the coated particulates. In some embodiments, the polybutadiene is one that is described herein and above. In some embodiments, the total weight of the polybutadiene to the weight of the particulates is in a ratio of about 1.0:1000 to about 3.0:1000 or any ratio in between. In some embodiments, the ratio (polybutadiene:particulate) is about 1.5:1000 to about 3.0:1000, about 2.0:1000 to about 3.0:1000, about 2.1:1000 to about 3.0:1000, about 2.2:1000 to about 3.0:1000, about 2.3:1000 to about 3.0:1000, about 2.4:1000 to about 3.0:1000, about 2.5:1000 to about 3.0:1000, about 2.6:1000 to about 3.0:1000, about 2.7:1000 to about 3.0:1000, about 2.8:1000 to about 3.0:1000, or about 2.9:1000 to about 3.0:1000. In some embodiments, the ratio (polybutadiene:particulate) is about 1.0:1000, about 1.1:1000, about 1.2:1000, about 1.3:1000, about 1.4:1000, about 1.5:1000, about 1.6:1000, about 1.7:1000, about 1.8:1000, about 1.9:1000, about 2.0:1000, about 2.1:1000, about 2.2:1000, about 2.3:1000, about 2.4:1000, about 2.5:1000, about 2.6:1000, about 2.7:1000, about 2.8:1000, about 2.9:1000, or about 3.0:1000. In some embodiments, the ratio of the polybutadiene:particulate is about 1.0:500 to about 2.0:500, about 1.1:500 to about 2.0:500, about 1.2:500 to about 2.0:500, about 1.25:500 to about 2.0:500, about 1.3:500 to about 2.0:500, about 1.4:500 to about 2.0:500, about 1.4:500 to about 2.0:500, about 1.5:500 to about 2.0:500, about 1.6:500 to about 2.0:500, about 1.7:500 to about 2.0:500, about 1.8:500 to about 2.0:500, about 1.9:500 to about 2.0:500, about 1.1:500, about 1.15:500, about 1.2:500, about 1.25:500, about 1.3:500, about 1.35:500, about 1.4:500, about 1.45:500, or about 1.5:500.

In some embodiments, the total weight of the fumed silica to the weight of the particulates is in a ratio of about 1.5:1000 to about 2.5:1000, about 0.5:1000 to about 3.0:1000, about 1.0:1000 to about 3.0:1000, about 2.0:1000 to about 3.0:1000, about 2.2:1000 to about 3.0:1000, about 2.5:1000 to about 3.0:1000, or any ratio in between. In some embodiments, the ratio is about 0.5:1000 to about 1.5:1000, about 0.75:1000 to about 1.25:1000, about 0.8:1000 to about 1.15:1000, about 0.9:1000 to about 1.1:1000, or about 1:5:1000 to about 2.0:1000(1:500). In some embodiments, the ratio of the fumed silica to the particulate is about 0.5:1000, about 0.6:1000, about 0.7:1000, about 0.8:1000, about 0.9:1000, about 1.0:1000, about 1.1:1000, about 1.2:1000, about 1.3:1000, about 1.4:1000, about 1.5:1000, about 1.6:1000, about 1.7:1000, about 1:8:1000, about 1.9:1000, about 2.0:1000, about 2.1:1000, about 2.2:1000, about 2.3:1000, about 2.4:1000, about 2.5:1000, about 2.6:1000, about 2.7:1000, about 2.8:1000, about 2.9:1000, or about 3.0:1000.

In some embodiments, the polybutadiene, the fumed silica, and the particulates are mixed simultaneously. In some embodiments, the polybutadiene is mixed with the particulates prior to the particulates being mixed with the fumed silica. In some embodiments, the method is performed at a temperature of about 50 to about 100 F. In some embodiments, the method is performed at a temperature of about 60 to about 90 F. In some embodiments, the method is performed at a temperature of about 70 to about 75 F. In some embodiments, the method is performed at a temperature of about 70 to about 80 F, about 70 to about 75 F, about 75 to about 80 F. In some embodiments, the method is performed at about 65 to about 75 F or other temperature ranges described herein and above. In some embodiments, the particulates are mixed with the polybutadiene and the fumed silica for about 2 to about 3 minutes.

The hydrophobic coated particulates described herein can be used in conjunction with cleaning out a well bore after gas or oil has been extracted. For example, after the particulates have been injected into the well, some of the particles may end up in the well bore. This well bore can be cleaned out so as not to be clogged by the particles. This clean out can be performed by various methods. In some embodiments, methods of cleaning out a well bore comprising a coated particulate described herein, the method comprising injecting a gas into the well bore to suspend the coated particulates in the well bore and displacing the coated particulate from the well bore. In some embodiments, the gas is air, nitrogen, carbon dioxide, or any combination thereof. In some embodiments, the displacing comprises injecting a fluid into the well bore to displace the suspended particulates from the well bore.

The solids and particulates described herein that can be treated are, and remain, finely divided, free-flowing, solids that generally have a size of about 0.2 mm to about 1 mm. Such solid sizes are used in hydraulic fracturing to prop open cracks formed downhole within the fractured strata. Such crack props, or “proppants” as they are known, must resist the crushing forces of crack closure to help maintain the flow of liquids and gases that have been trapped in the strata. Materials often used as proppant include coated and uncoated sand, bauxite, and ceramic proppant materials. All such materials are suitable for use in the methods and processes described herein. These include, but are not limited to, those that are coated with a coating comprising a compatibilizing agent, a hydrophobic polymer, and/or a cured and/or curable hydrophobic polymer. As described herein, the coated particulate can be combined with a gas, such as nitrogen, and the fracturing fluids as described herein.

The coated particulates, which can also be referred to as coated proppants, in combination with the fracturing fluid systems described herein can be used in a gas or oil well. For example, the proppants can be used in a fractured subterranean stratum to prop open the fractures as well as use the properties of the proppant in the process of producing the oil and/or gas from the well. In some embodiments, the proppants are contacted with the fractured subterranean stratum. The proppants can be contacted with the fractured subterranean stratum using any traditional methods for introducing proppants and/or sand into a gas/oil well. In some embodiments, a method of introducing a proppant into a gas and/or oil well is provided. In some embodiments, the method comprises placing the proppants into the well. In some embodiments, the well is a well that has already been fractured. Therefore, in some embodiments, methods of refracking a well are provided. In some embodiments, the method comprises contacting (injecting) coated particulates into a well that has been previously fractured and has coated particulates (proppants) are in the fractured subterranean stratum. In some embodiments, the coated particulates that are injected are the particulates described herein comprising a coating comprising the compatibilizing agent and the hydrophobic polymer. In some embodiments, the method comprises contacting a fractured subterranean stratum comprising proppants with a coated particulate, wherein the coated particulate comprises a particulate core with a compatibilizing agent and a hydrophobic polymer coating the particulate core, wherein a portion of the hydrophobic polymer is exposed to provide an exposed hydrophobic surface of the coated particulate. In some embodiments, the method comprises extracting oil and/or gas from the refractured subterranean stratum. The methods for extracting the oil and/or gas can be any method suitable to extract such oil and gas.

In some embodiments, the particulates are injected with a gas or a gas is injected after the particulates are contacted with the subterranean stratum. In some embodiments, the gas is nitrogen, air, or carbon dioxide. As described herein for any of the methods, the subterranean stratum can be fractured and can optionally already have proppants present in the fractured subterranean stratum. In some embodiments, the gas is a mixture of gases. In some embodiments, the gas or mixture of gasses is a nonpolar gas or a mixture of nonpolar gases. In some embodiments, the gas or mixture of gases is nitrogen, air, carbon dioxide, or any combination thereof. In some embodiments, the gas results in bubble formation on the hydrophobic surface of the proppant. Without being bound to any particular theory, the bubble formation can enhance the transport of the coated particulates in the subterranean stratum.

The coated particulate cores described herein can also be used to increase oil mobility out of a fractured subterranean stratum. Accordingly, in some embodiments, method of increasing oil mobility out of a fractured subterranean stratum are provided. In some embodiments, the method comprises injecting into a fractured subterranean stratum a coated particulate comprising a particulate core with a compatibilizing agent and a hydrophobic polymer coating the particulate core, wherein a portion of the hydrophobic polymer is exposed to provide an exposed hydrophobic surface of the coated particulate; and extracting the oil and/or gas from the fractured subterranean stratum with increased. In some embodiments, the coated particulate cores are those as described herein.

As described herein, particulate cores coated with certain coatings can have reduced dust production. Thus, in some embodiments, methods of extracting oil and/or gas from a subterranean stratum with reduced dust production are provided. In some embodiments, the methods comprise injecting into the subterranean stratum a coated particulate comprising a particulate core with a compatibilizing agent and a hydrophobic polymer coating the particulate core, wherein a portion of the hydrophobic polymer is exposed to provide an exposed hydrophobic surface of the coated particulate; and extracting the oil and/or gas from the subterranean stratum, wherein an amount of dust produced is less as compared to an uncoated particulate. In some embodiments, the coated particulate cores are those as described herein. Having reduced dust can have many benefits. For example, the reduction in dust will reduce the air borne silica on the wellsite and it can also minimize the damage that may be done to the fracture conductivity due to fines flowing through the proppant pack.

As described herein, the particulates can be used in for hydraulically fracturing and the techniques for such activities in a subterranean formation will be known to persons of ordinary skill in the art, and will, for example, involve pumping the fracturing fluid into the borehole and out into the surrounding formation. The fluid pressure is above the minimum in situ rock stress, and above the pressure that formation rock can resist without failure thus creating or extending fractures in the formation. In order to maintain the fractures formed in the formation after the release of the fluid pressure, the fracturing fluid carries a proppant whose purpose is to prevent the fracturing from closing after pumping has been completed.

The fracturing liquid that can be used with the coated particulates, such as the proppants, described herein can be, for example, a fracturing fluid that comprises a cross-linked or cross-linkable fracturing fluid, wherein the fluid has a density as described herein. In some embodiments, the fluid density can range from that of fresh water to that of a formation brine. Density may decrease some with increasing temperature, but not significantly. In some embodiments, the fluid comprises a guar polymer or a guar polymer derivative that is crosslinked with borate, zirconium, or titanium at a pH of about 4 to about 12. In some embodiments, the borate crosslinked fluids are crosslinked at a pH of about 8 to about 12 or about 8 to about 10. In some embodiments, the zirconate and titanium crosslinked fluids are cross linked at a pH of about 4 to about 5. In some embodiments, the titanium crosslinked fluids are cross linked at a pH of about 7 to about 8. In some embodiments, the guar polymer derivate is hydroxypropyl guar (HPG), carboxymethyl hydroxypropyl guar (CMHPG), or carboxymethyl guar (CMG), and any combination thereof.

In some embodiments, the base viscosity of the fracturing fluid prior to crosslinking has at least a viscosity of at about 10 to about 54 centipoises (as measured by a Brookfield DV-E viscometer being operated at 60 RPM's) and a crosslinked viscosity in the fractured subterranean of about 100 to about 1200 centipoise (measured at fracture temperature with a Fann model 50 viscometer at 100 sec⁻¹). In some embodiments, the fracturing fluid retains its ability to suspend the hydrophobic coated particulate after being subjected to high shear. In some embodiments, the high shear is about 1000 to about 10000 sec⁻¹. In some embodiments, the fracturing fluid comprises a composition, comprising at least 0.05 wt. % of one or more rheology-modifying star macromolecules, wherein the one or more rheology-modifying star macromolecules comprises: a) a molecular weight of greater than 100,000 g/mol; b) a core having a hydrophobic crosslinked polymeric segment; and c) a plurality of hydrophilic-segment-containing arms comprising at least two types of arms, wherein a first-arm-type extends beyond a second-arm-type and said first-arm-type has a hydrophobic segment on its distal end; and wherein the composition has a shear-thinning value of at least 6. Other examples of such fluids are described in U.S. Pat. No. 8,604,132, which is incorporated by reference in its entirety.

The following examples are not to be limiting and are only some of the embodiments encompassed by the presently disclosed subject matter.

### EXAMPLES

### Example 1: Coated Sands

A non-limiting example of how such the coated sand that is combined with the fracturing fluid was made is provided here. Dry 20/40 mesh sand (2000 g) is heated to between 180 F and 190 F. Into a syringe, 2.0 g of triethoxy(octyl)silane is weighed; into a second syringe 5.0 g of Evonik VESTOPLAST® W-1750 (amorphous poly-alpha-olefins dispersion) is weighed; into a third syringe 2.0 g of Chembetaine™ CAS is weighed. The hot sand is transferred to the three liter bowl of a Kitchen Aide Professional 600 mixer having the spade shaped blade, and the sand is maintained at 170 F in the center. The mixer is started at a speed setting of “5” and stirring is maintained during additions. Over 20 seconds the 2.0 g of triethoxy(octyl)silane is added and the mixture is allowed to stir for another 20 seconds. Over the next 30 seconds, the VESTOPLAST® W-1750 (amorphous poly-alpha-olefins dispersion) is added and the system is allowed to stir for another 60 seconds. Over the next 20 seconds the Chembetaine™ CAS is added and the system is allowed to stir for another 30 seconds. The mixer is turned off and the sand is allowed to cool. Sand of 40/70 mesh was also used to create a coated sand.

### Example 2. Coated Sands

Dry 20/40 mesh sand (2000 g) is heated to between 250 F and 270 F. Into a syringe, 2.0 g of an Example 6 emulsion containing alkylethoxylates and acrylamide is weighed; into a second syringe 5.0 g of Evonik VESTOPLAST® W-1750 (amorphous poly-alpha-olefins dispersion) is weighed. The hot sand is transferred to the three liter bowl of a Kitchen Aid Professional 600 mixer having the spade shaped blade, and the sand is maintained at 250 F in the center. The mixer is started at a speed setting of “5” and stirring is maintained during additions. Over 20 seconds the 2.0 g of alkylethoxylates and acrylamide is added and the mixture is allowed to stir for another 20 seconds. Over the next 30 seconds, the VESTOPLAST® W-1750 (amorphous poly-alpha-olefins dispersion) is added and the system is allowed to stir for another 110 seconds. The mixer is turned off and the sand is allowed to cool. Sand of 40/70 mesh was also used to create a coated sand.

### Example 3. Coated Sands

Dry 20/40 mesh sand (2000 g) was heated to between 250 F and 270 F. Into a syringe, 5.0 g of Evonik VESTOPLAST® W-1750 (amorphous poly-alpha-olefins dispersion) was weighed; into a second syringe 2.0 g of CHEMBETAINE™ CAS (cocamidopropyl hydroxysultaine) was weighed. The hot sand was transferred to the three liter bowl of a Kitchen Aide Professional 600 mixer having the spade shaped blade; the sand temperature was 248 F in the center. The mixer was started at a speed setting of “5” and stirring is maintained during additions. The sand was treated with the cocamidopropyl hydroxysultaine and the VESTOPLAST® W-1750 (amorphous poly-alpha-olefins dispersion). The mixer was turned off and the sand was allowed to cool.

### Example 4: Crosslinked Polyalphaolefins Form a Hydrophobic Coated Particulate

A 1.53 g portion of 6.67% AIBN in acetone was added to 10.00 g of VESTOPLAST® W-1750 (amorphous poly-alpha-olefins dispersion). The mixture was stirred for 3 minutes maintaining a stable emulsion, and then within 10 minutes, 5.75 g of this mixture was added to 2.00 kg of 40/70 sand at 250 F, stirring in a KitchenAide mixer (5.75 g mixture delivers 5.0 g of VESTOPLAST® W-1750 (amorphous poly-alpha-olefins dispersion)). After two minutes of stirring following completion of the additions, the product was allowed to cool. A 1.50 g portion of 6.67% dicumyl peroxide in acetone was added to 10.00 g of VESTOPLAST® W-1750 (amorphous poly-alpha-olefins dispersion). The mixture was stirred for 3 minutes maintaining a stable emulsion, then within 10 minutes, 5.75 g of this mixture was added to 2.00 kg of 40/70 sand at 250 F, stirring in a KitchenAide mixer. After two minutes of stirring following completion of the additions, the product was allowed to cool. A 3.00 g portion of 1.44% ferrous sulfate heptahydrate in water was added to 2.00 kg of 40/70 sand at 250 F stirred in a KitchenAide mixer, immediately followed by addition of a mixture containing 5.00 g of VESTOPLAST® W-1750 (amorphous poly-alpha-olefins dispersion) and 0.162 g of 30% hydrogen peroxide. After two minutes of stirring following completion of the additions, the product was allowed to cool.

### Example 5. Hydrophobic Coated Sand

Sand was placed in a mixer and allowed to mix for about 5 seconds. An alkoxylated alcohol/acrylic polymer mixture was added in a ratio of about 1:1000 (alkoxylated alcohol/acrylic polymer mixture:sand) and allowed to mix for about 15 seconds after the entire mixture was added to the sand. Subsequently, an amorphous polyalphaolefin (e.g. VESTOPLAST® W-1750 (amorphous poly-alpha-olefins dispersion)) was added to the mixture and allowed to mix for an additional 20 seconds. The amorphous polyalphaolefin was added in a ratio of about 1.25:1000 (polyalphaolefin:sand). A second amount of the same amorphous polyalphaolefin was mixed in a ratio of about 1.25:1000 (polyalphaolefin:sand) and allowed to mix for about 50 seconds. The coated sand was discharged from the mixer and was ready to use for any purpose, such as extraction of oil and gas. The sand was found to be coated with a hydrophobic coating.

### Example 6: Preparation of Hydrophobic Coated Sand

Sand was placed in a mixer and allowed to mix for about 5 seconds. An alkoxylated alcohol/acrylic polymer mixture was added in a ratio of about 1:1000 (alkoxylated alcohol/acrylic polymer mixture:sand) and allowed to mix for about 10-15 seconds after the entire mixture was added to the sand. Subsequently, fumed silica (CAB-O-SPERSE PG022) was added to the mixture in a ratio of about 1:1000 to 1.25:1000 (fumed silica:sand) and allowed to mix for about 10-20 seconds after the entire mixture was added to the sand. With the fumed silica, an amorphous polyalphaolefin (e.g. VESTOPLAST® W-1750 (amorphous poly-alpha-olefins dispersion)) was added to the mixture and allowed to mix. The amorphous polyalphaolefin was added in a ratio of about 1:400 (polyalphaolefin:sand). The mixer continued to mix for about another 30 seconds and then coated sand was discharged from the mixer. The mixing was done at a temperature of about 250° F. The sand was preheated. The coated sand was discharged from the mixer and was ready to use for any purpose, such as extraction of oil and gas. The sand was found to be coated with a hydrophobic coating.

### Example 7: Preparation of Hydrophobic Coated Sand

Sand was placed in a mixer and allowed to mix for about 5 seconds. An alkoxylated alcohol/acrylic polymer mixture was added in a ratio of about 0.7:1000 (alkoxylated alcohol/acrylic polymer mixture:sand) and allowed to mix for about 10 seconds. Subsequently, fumed silica (CAB-O-SPERSE PG022) was added to the mixture in a ratio of about 0.9:1000 (fumed silica:sand) and allowed to mix for about 10-20 seconds. With the fumed silica, an amorphous polyalphaolefin (e.g. VESTOPLAST® W-1750 (amorphous poly-alpha-olefins dispersion)) was added to the mixture and allowed to mix. The amorphous polyalphaolefin was added in a ratio of about 1:500 (polyalphaolefin:sand). The mixer continued to mix for about another 15-20 seconds and then coated sand was discharged from the mixer. The mixing was done at a temperature of about 250° F. The sand was preheated as described herein. The coated sand was discharged from the mixer and was ready to use for any purpose, such as extraction of oil and gas. The sand was found to be coated with a hydrophobic coating.

### Example 8: Preparation of Hydrophobic Coated Sand

Sand was placed in a mixer and allowed to mix for about 5 seconds. Subsequently, fumed silica (CAB-O-SPERSE PG022) was added to the mixture in a ratio of about 1:500 (fumed silica:sand) and allowed to mix for about 5-35 seconds. Simultaneously, polybutadiene (e.g. POLYVEST 58) was added to the mixture and allowed to mix for about 5-45 seconds. The polybutadiene was added in a ratio of about 1.25:500 (polybutadiene:sand). The mixer continued to mix for about another 40-105 seconds and then coated sand was discharged from the mixer. The mixing was done at a temperature of about 75° F. The sand can be preheated or not. The sand was found to be coated with a hydrophobic coating.

### Example 9: Design and Implementation of a Fracturing Treatment

To identify a proppant transport and suspension system and the resulting maximum propping of the created fracture area an estimate of the time it will take (after the completion of the fracturing treatment) for the fracture to close is determined. This estimate is made from monitoring downhole or wellhead pressure of an adjacent well (after its fracturing treatment has been completed) or by calculation of the closure time using a fracture design computer program or reservoir simulator. The use of a design program or reservoir simulator would take into account parameters such as, but not limited to:
a) Formation permeability
b) Formation temperature
c) Fracturing fluid rheology
d) Fracturing fluid leak-off
e) Expected proppant concentration
f) Dynamic fracture width at the completion of the fracturing treatment

Once an estimate (for the time required for the fracture to close) is determined, suspension tests (described in Example 10) at a simulated formation temperature are run to determine the crosslinked fracturing fluid, gas level and hydrophobic coated proppant combination that results in the proppant suspension that meets or exceeds the estimated fracture closure time. The options that are found to meet or exceed the estimated closure time can also be formulated to include a breaker technology so that it can be sure that the fracturing fluid formulation will not only lead to enhanced transport and suspension, but will also have an acceptable breakout (viscosity reduction), minimal conductivity damage to the fracture faces and proppant pack and subsequent well cleanup. Suspension tests are repeated with samples that include the prescribed breaker system to verify that the resulting fracturing fluid, gas and hydrophobic coated proppant combination are capable of keeping proppant suspended for a time period that meets or exceeds the estimated fracture closure time.

### Example 10

Suspension test to determine fracturing fluid, gas and hydrophobic coated proppant combination can be used to achieve “perfect proppant transport and suspension. Once a measurement or calculation of the time required for the fracture to close (after completion of a fracturing treatment) has been obtained according to Example 9, proppant suspension tests are run in a constant temperature environment that simulates the expected downhole temperature that exist in the well. Suspension tests (performed at the expected downhole temperature) are run using the following equipment and procedures, which can be used with any fracturing fluid/proppant (coated particulate) combination being examined to determine proppant suspension as a function of time (at a simulated downhole temperature).

1. Equipment:
1.1. 120 g of hydrophobic coated particulate
1.2. Variable speed blender
1.3. Stimulation Chemical at Desired Concentration
1.4. 500 ml of water with ≥2% added KCl
1.5. Quart jar with lid
1.6. Oven capable of 200° F.

2. Procedure:
2.1. Pour into the blender jar 500 ml of water that represents the base fluid used in a fracturing treatment, such as 2% added KCl.
2.2. Start variable speed blender at a low shear/speed.
2.3. Add the desired chemicals (to be used in the fracturing treatment) letting it mix for about 5 to about 10 minutes.
2.4. Turn blender up to high shear or desired speed.
2.5. Add the chosen coated particulate (proppant) and let it mix for a duration of about 15 to about 30 seconds.
2.6. Record and photograph the amount of suspended sand.
2.7. Pour contents of the blender into a quart jar and place lid on jar (tighten until air tight)
2.8. Place jar into the oven set at the simulated downhole temperature (maximum test temperature <200° F.).
2.9. Observe and photograph the samples as a function of time. Once the sample is placed in the constant temperature oven it should be handled as little as possible, if at all, until the test is completed because handling can dramatically impact the observed suspension levels.

Once samples (combinations of a crosslinked fracturing fluid, gas and hydrophobic coated proppant) have been identified that meet or exceeds the expected fracture closure time the tests can be terminated. Any fracturing fluid system that is found to be a part of the combination that met the time requirements is reformulated to include a fracturing fluid breaker to ensure proper viscosity reduction and well cleanup. The reformulated fracturing fluid, gas and proppant combination are rerun (using the suspension test protocol) to verify that the inclusion of the breaker does not prohibit the combination from meeting or exceeding the estimated closure time of the fracture.

Execution of the “perfect proppant transport and suspension” treatment design. Once the crosslinked fracturing fluid formulation, gas level and hydrophobic coated proppant formulation are identified, the pumping schedule is developed that specifies the amounts of proppant to be pumped in each segment of the fracturing treatment. The development of the pumping schedule allows for the quantities of all components (to be used) to be determined and arrangements made to schedule their availability. All required components are transported to the wellsite for use. The hydrophobic coated proppant is stored in field bins and when the treatment is started, transported to the blender tub (a non-limiting example method of mixing the proppant and fracturing fluid together) at the prescribed amounts using, for example, conveyor belts. The base polymer (either guar or guar derivative) is transported to the wellsite in either a dry or slurried form. At the wellsite it is hydrated in the base fluid (water) in the blender tub or in a specially designed hydration unit and then pumped to the blender tub where it is mixed with the coated proppant and the crosslinking solution (either borate, zirconate or titanium compound). This mixture is fed to the high pressure pumps and from there to the wellhead to begin its journey downhole. Between the high pressure pumps and the wellhead the nitrogen/gas is added to the slurry mixture. Without being bound to any particular theory, the bubble layer forms sometime after the nitrogen/gas is added but before the slurry enters the fracture. The fracturing fluid crosslinks sometime after passing through the high pressure pumps but before the slurry mixture leaves the wellbore and enters the fracture. This process continues (following the developed pumping schedule) until the proppant schedule is completed and the slurry is displaced to the perforation to clear the wellbore. The well is then shut-in to allow the fracture to close and the fracturing fluid to break out. During this shut-in period the downhole and wellhead pressures are recorded to help verify when the fracture has closed on the proppant. After a prescribed shut-in period (determined by the fracture closure and the breaker schedule) the well is opened up to begin the clean-up process.

The examples described herein demonstrate that a gas combined with particulate coated with the coatings described and a crosslinked or crosslinkable polymer described herein have surprising and unexpected properties and lead to a significant improvement in sand transport that could not have been predicted.

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

It must also be noted that as used herein and in the appended claims, the singular forms “a”, “an”, and “the” include plural reference unless the context clearly dictates otherwise.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Various references and patents are disclosed herein, each of which are hereby incorporated by reference for the purpose that they are cited.

From the foregoing, it will be appreciated that various embodiments of the present disclosure have been described herein for purposes of illustration, and that various modifications can be made without departing from the scope and spirit of the present disclosure. Accordingly, the various embodiments disclosed herein are not intended to be limiting.

What is claimed is:

1. A method of extracting oil and/or gas from a subterranean stratum, the method comprising:
injecting into the subterranean stratum a mixture of a hydrophobic coated particulates, gas, and a fracturing fluid through a wellhead and into the fractured subterranean stratum, wherein the fracturing fluid comprises a cross-linked or cross-linkable polymer; and
extracting the oil and/or gas from the subterranean stratum.
wherein the combination of the fluid, gas, and hydrophobic coated particulate results in the hydrophobic coated particulate being suspended for a period of time that approaches or exceeds the time required for the fracture to close thereby maximizing the amount of created fracture area that is held open by hydrophobic coated particulate.

2. The method of claim 1, wherein the fracturing fluid comprises a guar polymer or a guar polymer derivative that is crosslinked with borate, zirconium, or titanium at a pH of about 4 to about 12.

3. The method of claim 2, wherein the fluid is crosslinked at a pH of about 8 to about 12.

4. The method of claim 3, wherein the fluid is crosslinked with borate.

5. The method of claim 2, wherein the fluid is crosslinked at a pH of about 4 to about 5.

6. The method of claim 5, wherein the fluid is crosslinked with zirconium or titanium.

7. The method of claim 2, wherein the fluid is crosslinked at a pH of about 7 to about 8.

8. The method of claim 7, wherein the fluid is crosslinked with titanium.

9. The method of claim 2, wherein the polymer is a guar polymer or guar derivative polymer.

10. The method of claim 9, wherein the polymer is hydroxypropyl guar (HPG), carboxymethyl hydroxypropyl guar (CMHPG) or carboxymethyl guar (CMG).

11. The method of claim 1, wherein the base viscosity of the fracturing fluid prior to crosslinking has at least a viscosity of at about 10 to about 54 centipoises (as measured by a Brookfield DV-E viscometer being operated at 60 RPM's) and a crosslinked viscosity in the fractured subterranean of about 100 to about 1200 centipoise (measured at fracture temperature with a Fann model 50 viscometer at 100 sec⁻¹).

12. The method of claim 1, wherein the fracturing fluid retains its ability to suspend the hydrophobic coated particulate after being subjected to high shear while being pumped through tubular goods prior to entering the perforations and created fracture.

13. The method of claim 12, wherein the high shear is about 1000 to about 10000 sec⁻¹.

14. The method of claim 1, wherein the fracturing fluid comprises a composition, comprising at least 0.03 wt. % of one or more rheology-modifying star macromolecules, wherein the one or more rheology-modifying star macromolecules comprises: a) a molecular weight of greater than 100,000 g/mol; b) a core having a hydrophobic crosslinked polymeric segment; and c) a plurality of hydrophilic-segment-containing arms comprising at least two types of arms, wherein a first-arm-type extends beyond a second-arm-type and said first-arm-type has a hydrophobic segment on its distal end; and wherein the composition has a shear-thinning value of at least 6.

15. The method of claim 1, wherein the polymer is present in an amount of about 10 to about 40 lbs per 1000 gal of fracturing fluid.

16. The method of claim 1, wherein the polymer is present in an amount of about 10 to about 30 lbs per 1000 gal of fracturing fluid.

17. The method of claim 1, wherein the polymer is present in an amount of about 30 to about 40 lbs per 1000 gal of fracturing fluid.

18. The method of claim 1, wherein the polymer is present in an amount of about 20 to about 40 lbs per 1000 gal of fracturing fluid.

20. The method of claim 1, wherein the gas is air, nitrogen, carbon dioxide, combination thereof.

21. The method of claim 1, wherein the gas is nitrogen.

22. The method of claim 1, the method further comprising mixing the hydrophobic coated particulate with the fracturing fluid prior to being injected into the wellhead.

23. The method of claim 1, wherein the hydrophobic coated particulate is a coated particulate comprising a hydrophobic coating, wherein the hydrophobic coating is a mixture of 1) an alkoxylate or an alkoxylated alcohol, 2) an acrylic polymer, and 3) an amorphous polyalphaolefin.

24. The method of claim 23, wherein the coating further comprises fumed silica.

25. The method of claim 1, wherein the particulate is a sand particle, a bauxite particle or a ceramic particle.

26. The method of claim 23, wherein the alkoxylate has a formula of Formula I, II, III, IV, or V:
RₐO-(AO)₂—H (I),
wherein Rₐ is aryl (e.g., phenyl), or linear or branched C₆-C₂₄ alkyl, AO at each occurrence is independently ethyleneoxy, propyleneoxy, butyleneoxy, or random or block mixtures thereof, and z is from 1 to 50;
R—O—(C₃H₆O)ₓ(C₂H₄O)_{y}—H (II),
wherein x is a real number within a range of from 0.5 to 10; y is a real number within a range of from 2 to 20, and R represents a mixture of two or more linear alkyl moieties each containing one or more linear alkyl group with an even number of carbon atoms from 4 to 20;
R¹O—(CH₂CH(R²)—O)ₚ—(CH₂CH₂O)_{q}—H (III),
wherein R¹ is linear or branched C₄-C₁₈ alkyl; R² is CH₃ or CH₃CH₂; p is a real number from 0 to 11; and q is a real number from 1 to 20;
Rₐ—O—(C₂H₄O)ₘ(C₄H₈O)ₙ—H (IV),
wherein Rₐ is one or more independently straight chain or branched alkyl groups or alkenyl groups having 3-22 carbon atoms, m is from 1 to 12, and n is from 1 to 8;
C₄H₉O—(C₂H₄O)ᵣ(C₃H₉O)ₛ(C₂H₄O)ₜ—H (V),
wherein r is from 3-10, s is from 3 to 40, and t is from 10 to 45;
R—O—(-CH—CH₃—CH₂—O—)ₓ-(—CH₂—CH₂—O—)_{y}-H (VI),
wherein x is from 0.5 to 10, y is from 2 to 20, and R is a mixture of two or more linear alkyl moieties having an even number of carbon atoms between 4 and 20.

27. The method of claim 23, wherein the an acrylic polymer comprises an aqueous dispersion of particles made from a copolymer, based on the weight of the copolymer, comprising:
i) from 90 to 99.9 weight percent of at least one ethylenically unsaturated monomer not including component ii; and
ii) from 0.1 to 10 weight percent of (meth)acrylamide.

28. The method of claim 23, wherein the wherein the an acrylic polymer comprises an aqueous dispersion of particles made from a copolymer, based on the weight of the copolymer, comprising:
i) from 80 to 99.9 weight percent of at least one ethylenically unsaturated monomer not including component ii; and
ii) from 0.1 to 20 weight percent of a carboxylic acid monomer.

29. The method of claim 23, wherein the wherein the an acrylic polymer comprises an aqueous dispersion of particles made from a copolymer, based on the weight of the copolymer, comprising:
i) from 75 to 99 weight percent of at least one ethylenically unsaturated monomer not including component ii;
ii) from 1 to 25 weight percent of an ethylenically unsaturated carboxylic acid monomer stabilized with a polyvalent metal.

30. The method of any one of claims 27-29, wherein the ethylenically unsaturated monomer is (meth)acrylic acid.

31. The method of claim 29, wherein the polyvalent metal is zinc or calcium.

32. The method of claim 23, wherein the acrylic polymer comprises a vinyl aromatic diene copolymer.

33. The method of claim 23, wherein the polyalphaolefin is a crosslinked polyalphaolefin polymer.

34. The method of claim 33, wherein the crosslinked polyalphaolefin polymer is a potassium persulfate crosslinked polyalphaolefin polymer, an azobisisobutylnitrile crosslinked polyalphaolefin polymer, or a ferrous sulfate-hydrogen peroxide crosslinked polyalphaolefin polymer.

35. The method of claim 1, wherein the coated particulate is substantially free of a hydrogel.

36. The method of claim 1, wherein the coated particulate is substantially free of a frother.

37. The method of claim 23, wherein the coating comprises a mixture a polybutadiene and fumed silica.

38. The method of claim 37, wherein the polybutadiene is a hydroxyl terminated polybutadiene.

39. The method of claim 38, wherein the hydroxyl terminated polybutadiene has an average M_{w} of about 6,200 and/or an average Mₙ of about 2,800.

40. The method of claim 38, wherein the hydroxyl terminated polybutadiene has a formula of 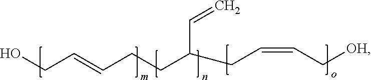
wherein m, n, and o are non-zero integers.

41. The method of claim 1, wherein the % wt of coating is less than or equal to about 1.0% wt of the particulate.

42. The method of claim 1, wherein the coated particulate comprises a particulate core coated with an optional compatibilizing agent and a hydrophobic polymer coating the particulate core, wherein a portion of the hydrophobic polymer is exposed to provide an exposed hydrophobic surface of the coated particulate.

43. The method of claim 42, wherein the compatibilizing agent binds the hydrophobic polymer to the particulate.

44. The method of claim 42 or 43, wherein the compatibilizing agent is an alkoxysilane.

45. The method of claim 44, wherein the alkoxysilane is a methoxysilane, ethoxysilane, butoxysilane, or octoxysilane.

46. The method of claim 42, wherein the compatibilizing agent is a surfactant.

47. The method of claim 46, wherein the surfactant is a hydroxysultaine.

48. The method of claim 42, wherein the compatibilizing agent is an alkoxylated alcohol.

49. The method of claim 42, wherein the compatibilizing agent is an acrylate polymer.

50. The method of claim 42, wherein the compatibilizing agent is a mixture of two or more of agents selected from the group consisting of acrylate polymer, alkoxylated alcohol, hydroxysultaine, surfactant, and alkoxysilane.

51. The method of claim 42, wherein the hydrophobic polymer is an amorphous polyalphaolefin.

52. The method of claim 42, wherein the hydrophobic polymer is a non-siloxane hydrophobic polymer.

53. The method of claim 42, wherein the hydrophobic polymer is a cured hydrophobic polymer.

54. The method of claim 42, wherein the hydrophobic polymer is a polybutadiene.

55. The method of claim 42, wherein the hydrophobic polymer is a cured polybutadiene.

56. The method of claim 42, wherein the % wt of the hydrophobic polymer is less than or equal to 0.5% wt of the particulate.

57. A method of determining an optimized proppant and fracturing fluid system for transporting proppants into a fractured subterranean, the method comprising:
determining the time required for the fracture to close; and
performing a suspension test on a combination of a proppant, fracturing fluid and gas to determine the combination that is near to or exceeding the time for the fracture to closed at elevated temperatures that are representative of the formation that is to be fracture stimulated,
wherein the fracturing fluid, gas and proppant combination that shows it is capable of keeping the coated proppant suspended for the time period identified in a) is selected as the optimized combination.

58. The method of claim 57, wherein determining the time required for the fracture to close comprises:
monitoring downhole or wellhead pressures (after the completion of a fracturing treatment) to obtain an estimate of how long it will take for the fracture to close onto the proppant after the fracturing treatment has been completed; or
implementing a fracture design program or reservoir simulator along with fluid rheology, fluid leak-off parameters and expected proppant concentration to estimate the dynamic width that was created during the fracturing treatment and how long after the fracturing treatment is completed it will take for the fracture to close trapping the proppant between the fracture faces.

59. The method of claim 57, wherein the suspension is repeated with a combination of the optimized combination solution further comprising a breaker to ensure that the inclusion of the breaker does not prohibit the combination from meeting or exceeding the estimated closure time of the fracture.
